(19) United States
(12) Patent Application Publication
(10) Pub. No.: US 2024/0212067 A1
(43) Pub. Date: Jun. 27, 2024

(54) INTERFACE DISPLAY METHOD AND APPARATUS, DEVICE, AND MEDIUM

(71) Applicant: Tencent Technology (Shenzhen) Company Limited, Shenzhen (CN)

(72) Inventor: Yilang XU, Shenzhen (CN)

(21) Appl. No.: 18/600,471

(22) Filed: Mar. 8, 2024

Related U.S. Application Data
(63) Continuation of application No. PCT/CN2023/083081, filed on Mar. 22, 2023.

(30) Foreign Application Priority Data
Jun. 22, 2022 (CN) 202210714195.0

(51) Int. Cl. G06Q 50/00; G06F 3/04845; G06F 3/0488; G06T 5/50; G09G 5/377

(52) U.S. Cl. CPC G06Q 50/01; G06F 3/04845; G06F 3/0488; G06T 5/50; G09G 5/377; G06T 2207/20221

(57) ABSTRACT

This application discloses an interface display method performed by a computer device. The method includes: displaying a feed interface of a first user account of a social networking platform, the feed interface comprising at least one object displayed within a frame of the feed interface; in response to an interactive operation on the first social content, displaying the at least one object breaking out of the frame and becoming a multimedia frame-breaking element of an interactive object with a body contour of the at least one object remaining within the frame; and displaying an information presenting interface associated with the interactive object in replacement of the feed interface in response to a triggering operation on the multimedia frame-breaking element.

### CROSS-REFERENCE TO RELATED APPLICATIONS

This application is a continuation application of PCT Patent Application No. PCT/CN2023/083081, entitled “INTERFACE DISPLAY METHOD AND APPARATUS, DEVICE, AND MEDIUM” filed on Mar. 22, 2023, which claims priority to Chinese Patent Application No. 202210714195.0, entitled “INTERFACE DISPLAY METHOD AND APPARATUS, DEVICE, AND MEDIUM” filed on Jun. 22, 2022, all of which is incorporated herein by reference in its entirety.

### FIELD OF THE TECHNOLOGY

This application relates to the field of man-machine interaction, and in particular, to an interface display method and apparatus, a device, and a medium.

### BACKGROUND OF THE DISCLOSURE

Nowadays, it is common to see advertisements placed on a feed interface. For example, an infomercial placed by a recommendation account is displayed in the feed interface, and the infomercial is presented in a form of social content sent by the recommendation account.

In related technologies, infomercials use materials such as text, pictures, and videos to briefly introduce a target product. For example, the feed interface displays social content sent by a recommendation account of a star, and a user enters a landing page by clicking/tapping on a material in the social content, and relevant information about target merchandise is presented in the landing page.

However, interaction between the infomercial and the user account in the related art is single, and can only be implemented by the user clicking/tapping on the social content sent by the recommendation account.

### SUMMARY

Embodiments of this application provide an interface display method and apparatus, a device, and a medium, enriching manners of interaction between a recommendation account and a first user account by displaying and triggering a multimedia frame-breaking element. A technical solution is as follows:

According to an aspect of this application, an interface display method is performed by a computer device, the method including:
displaying a feed interface of a first user account of a social networking platform, the feed interface comprising at least one object displayed within a frame of the feed interface;
in response to an interactive operation on the first social content, displaying the at least one object breaking out of the frame and becoming a multimedia frame-breaking element of an interactive object with a body contour of the at least one object remaining within the frame; and
displaying an information presenting interface associated with the interactive object in replacement of the feed interface in response to a triggering operation on the multimedia frame-breaking element.

According to an aspect of this application, a computer device is provided, the computer device including a memory and a processor.

The processor stores at least one piece of program code, and the program code is loaded and executed by the processor to implement the interface display method described above.

According to an aspect of this application, a non-transitory computer-readable storage medium is provided. The storage medium has a computer program stored therein, and the computer program is configured to be executed by a processor to implement the interface display method described above.

The technical solutions provided in the embodiments of this application include at least the following beneficial effects:
displaying the multimedia frame-breaking element of the interactive biological object through the interactive operation on the first social content; displaying the information presenting interface associated with the interactive biological object by triggering the multimedia frame-breaking element, enriching manners of interaction between the recommendation account and the first user account, and enriching types of man-machine interaction, thereby improving frequency of the interaction between the recommendation account and the first user account. In addition, an information display interface in the multimedia frame-breaking element focused by the user can be quickly and accurately opened by triggering the multimedia frame-breaking element, avoiding mis-recognition.

### BRIEF DESCRIPTION OF THE DRAWINGS

FIG. 1 is a structural block diagram of a computer system according to an exemplary embodiment of this application;

FIG. 2 is a schematic diagram of an interface of an interface display method according to an exemplary embodiment of this application;

FIG. 3 is a flowchart of an interface display method according to an exemplary embodiment of this application;

FIG. 4 is a flowchart of an interface display method according to an exemplary embodiment of this application;

FIG. 5 is a flowchart of an interface display method according to an exemplary embodiment of this application;

FIG. 6 is a flowchart of an interface display method according to an exemplary embodiment of this application;

FIG. 7 is a flowchart of an interface display method according to an exemplary embodiment of this application;

FIG. 8 is a flowchart of an interface display method according to an exemplary embodiment of this application;

FIG. 9 is a flowchart of an interface display method according to an exemplary embodiment of this application;

FIG. 10 is a flowchart of an interface display method according to an exemplary embodiment of this application;

FIG. 11 is a flowchart of an interface display method according to an exemplary embodiment of this application;

FIG. 12 is a flowchart of an interface display method according to an exemplary embodiment of this application;

FIG. 13 is a schematic diagram of an interface display apparatus according to an exemplary embodiment of this application;

FIG. 14 is a schematic diagram of an interface display apparatus according to an exemplary embodiment of this application; and

FIG. 15 is a structural block diagram of a computer device according to an exemplary embodiment of this application.

### DESCRIPTION OF EMBODIMENTS

Feed: a form of data that is continuously updated and presented to a user with content. The feed includes at least timeline-based presentation and random presentation. The timeline-based presentation refers to that the content is presented to the user in a time sequence of an update of content of the feed, that is, the content of the feed is presented based on the timeline. Random presentation refers to that a weight of the content is calculated according to some factors, and then a sequence of presenting the content is determined. For example, a weight of content posted by a subscription account is calculated according to an algorithm, and a sequence of the content posted by the subscription account recommended to the user is determined according to the weight. The feed also uses different forms of presentation to present the content, and common forms include, for example, a list form, a waterfall form, and a card form. The feed may also be considered to be obtained by aggregating at least one resource provided by at least one content source to which the user account subscribes.

Information (including, but not limited to, user device information, user personal information, and the like), data (including, but not limited to, data used for analysis, data stored, data presented, and the like), and signals involved in this application are authorized by the user or are fully authorized by the parties, and the collection, use, and processing of the relevant data are required to comply with relevant laws, regulations, and standards of the relevant countries and regions. For example, social content in the feed interface involved in this application is obtained with full authorization.

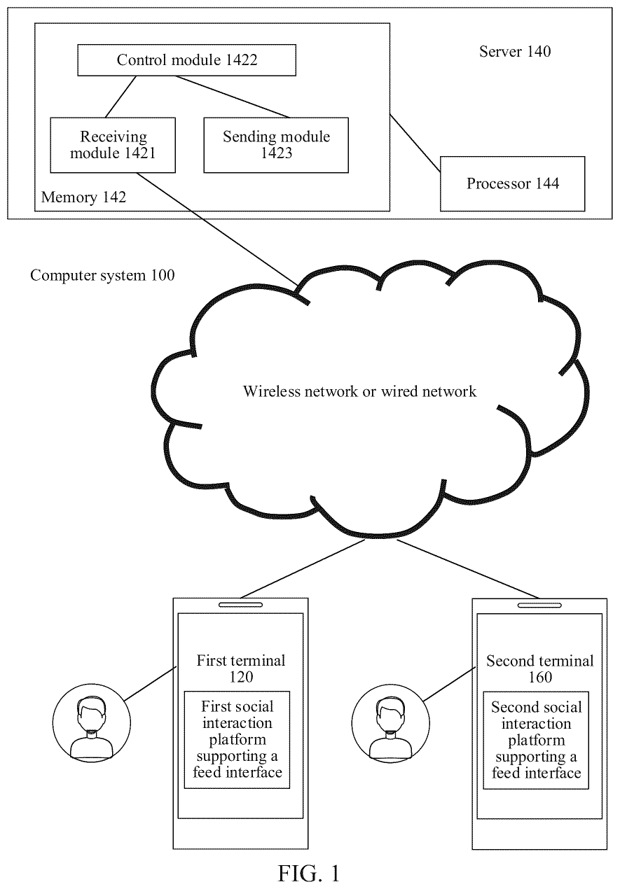

FIG. 1 is a structural block diagram of a computer system according to an exemplary embodiment of this application. The computer system 100 includes: a first terminal 120, a server 140, and a second terminal 160.

A first social interaction platform supporting a feed interface is installed and run on the first terminal 120. A first user account is logged in to the first social interaction platform, and the first user account may interact with a following account through the feed interface presented on the first social interaction platform. The first user account may perform operations such as approving, commenting, sharing, reporting, and not reading on content posted by a friend account or a following user account. The first terminal 120 is a terminal used by a first user. The first user may browse or post content on the feed interface of the first social interaction platform installed and run on the first terminal 120.

A second social interaction platform supporting a feed interface is installed and run on the second terminal 160. A second user account is logged in to the second social interaction platform, and the second user account may interact with a following account through the feed interface presented on the second social interaction platform. The second user account may perform operations such as approving, commenting, sharing, reporting, and not reading on content posted by a friend account or a following user account. The second terminal 160 is a terminal used by a second user. The second user may browse or post content on the feed interface of the social interaction platform installed and run on the second terminal 160.

In an embodiment, the first user account and the second user account are in a one-way following relationship. If the second user account posts content on the social interaction platform, the first user account can browse the content on the feed interface. However, if the first user account posts content on the social interaction platform, the second user account cannot browse the content on the feed interface.

In another embodiment, the first user account and the second user account are in a two-way following relationship. If the second user account posts content on the social interaction platform, the first user account can browse the content on the feed interface, and if the first user account posts content on the social interaction platform, the second user account can also browse the content the feed interface.

The first terminal 120 and the second terminal 160 are connected to the server 140 by using a wireless network or a wired network.

The server 140 includes at least one of one server, a plurality of servers, a cloud computing platform, and a virtualization center. For example, the server 140 includes a processor 144 and a memory 142. The memory 142 includes a receiving module 1421, a control module 1422, and a sending module 1423. The receiving module 1421 is configured to receive a request sent by the social interaction platform, for example, a request to like target social content. The control module 1422 is configured to control rendering of the feed interface. The sending module 1423 is configured to send a response to the social interaction platform, for example, send feedback to the social interaction platform on whether the like is successful. The server 140 is configured to provide a back-end service for supporting the social interaction platform. In some embodiments, the server 140 is responsible for primary computing work, and the first terminal 120 and the second terminal 160 are responsible for secondary computing work; or the server 140 is responsible for secondary computing work, and the first terminal 120 and the second terminal 160 are responsible for primary computing work; or the server 140, the first terminal 120, and the second terminal 160 are responsible for computing work collaboratively.

In some embodiments, the first social interaction platform and the second social interaction platform are the same social interaction platform on different operating system platforms (Android or iOS). In some embodiments, device types of the first terminal 120 and the second terminal 160 are the same or different. The device types include: at least one of a smartphone, a smartwatch, an in-vehicle terminal, a wearable device, a smart television, a tablet computer, an e-book reader, an MP3 player, an MP4 player, a laptop, and a desktop computer. The following embodiment is described by using an example in which the terminal includes a smartphone.

A person skilled in the art may learn that there may be more or fewer terminals. For example, there may be only one terminal, or there may be dozens of or hundreds of terminals or more. A quantity and the device type of the terminals are not limited in the embodiments of this application.

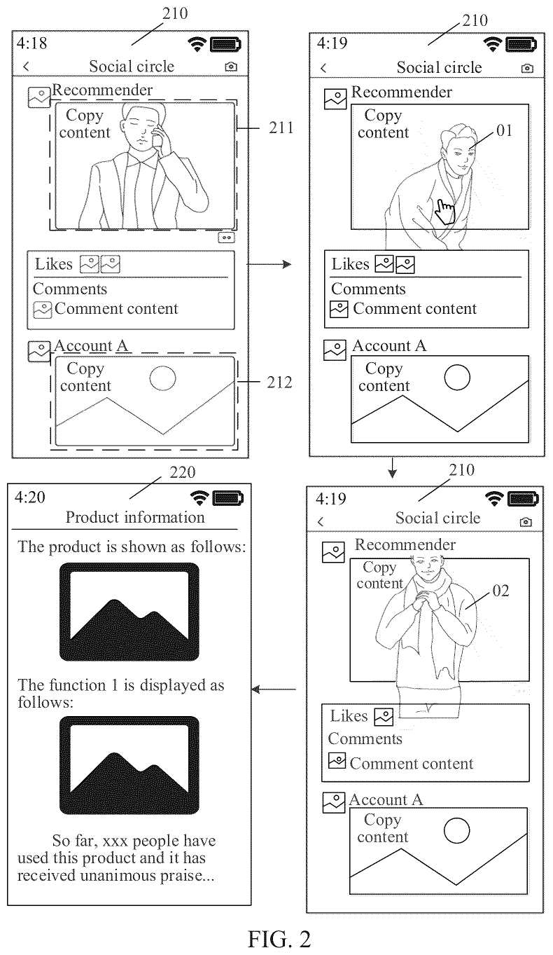

FIG. 2 is a schematic diagram of an interface display method according to an exemplary embodiment of this application.

An example in which the feed interface is a display interface 210 of a social circle of the first user account is used. First social content 211 sent by at least one recommendation account is displayed in the display interface 210.

The at least one recommendation account is an account that does not have a two-way following relationship with the first user account. For example, the recommendation account is an account randomly pushed by a system, or the recommendation account is an official account one-way followed by the first user account. Referring to FIG. 2, the recommendation account is a “Recommender”.

For example, at least one biological object is displayed in a display region of the first social content 211.

Referring to FIG. 2, the display region of the first social content 211 includes display positions of copy content and/or a picture sent by the recommender, and the first social content 211 includes three biological objects. The biological object is presented in an image of a recommendation character.

In an implementation, the biological object may further be presented in an image of a recommendation animal or an animated character. For example, the biological object is an image of a star; or the biological object is an image of an animated character; or the biological object is an image of a real animal.

In some embodiments, second social content 212 sent by at least one second user account is further displayed in the display interface 210. The at least one second user account is an account that has a two-way following relationship with the first user account. For example, the second user account is a friend account of the first user account. Referring to FIG. 2, the second user account is an “Account A”.

For example, in response to an interactive operation on the first social content 211, a multimedia frame-breaking element 01 of an interactive biological object in at least one biological object is displayed in the display interface 210. The multimedia frame-breaking element 01 is configured to present a visual image of an interactive biological object, and a display position of partial or all display content of the multimedia frame-breaking element 01 exceeds coverage corresponding to the display region of the first social content 211. The interactive biological object refers to a biological object displayed after interaction in the first social content 211; and the interactive biological object is at least one of the biological objects displayed in the display interface 210.

Referring to FIG. 2, a display region of the multimedia frame-breaking element 01 is a closed region with an irregular boundary, and the display position of the multimedia frame-breaking element 01 is a central part of the display interface 210. A part of the multimedia frame-breaking element covers the display region of the first social content 211, and the other part of the multimedia frame-breaking element is located in another region other than the display region of the first social content 211 in the display interface 210.

In some embodiments, the multimedia frame-breaking element 01 may also be presented as a floating layer in the display interface 210.

The display region of the multimedia frame-breaking element 01 is a floating region located on an upper layer of the display interface 210, and a layer level of the floating region is higher than a layer level of the display interface 210. It is to be understood that in the display interface 210, a part not covered by the display region of the multimedia frame-breaking element 01 can still be seen.

Referring to FIG. 2, an example in which the multimedia frame-breaking element 01 is a photo of a star is used, and the boundary of the display region of the multimedia frame-breaking element 01 is a body contour line of the star. In the display interface 210, a body part of the star is presented in a form floating above a layer of the social circle displayed in the display interface 210. Other than a part blocked by the body part of the star, other content in the social circle displayed in the display interface 210 can still be seen.

For example, a display effect of the multimedia frame-breaking element 01 is highlight, and a display effect of other content other than the part blocked by the body part of the star in the social circle displayed in the display interface 210 is a light color, for example, gray.

The multimedia frame-breaking element 01 may have a plurality of forms, including, but not limited to, the following forms: a picture, a video, and an animation. For example, the multimedia frame-breaking element 01 is presented in a form of a photo of the interactive biological object; or the multimedia frame-breaking element 01 is presented in a form of an animation of the interactive biological object.

Referring to FIG. 2, a user that logs in the first user account long-presses a recommendation character in the picture sent by the recommender, the terminal determines the recommendation character corresponding to a long-press operation of the user as the interactive biological object, and then the multimedia frame-breaking element 01 corresponding to the recommendation character is displayed in the display interface 210. The display position of the partial or all display content of the multimedia frame-breaking element 01 exceeds coverage corresponding to the display region of the copy content and the picture of the first social content 211.

In some embodiments, the interactive operation on the first social content 211 includes, but is not limited to, at least one of the following operations: a continuous pressing operation, a sliding operation, a single-click/tap operation, a double-click/tap operation, and a touch operation.

For example, the biological object is an image of a star, the user continuously presses a pattern of the star displayed in the display interface 210, the multimedia frame-breaking element 01 corresponding to the star is displayed in the display interface 210, and the multimedia frame-breaking element 01 is presented in a form of an artistic photo of the star.

In some embodiments, before the multimedia frame-breaking element 01 is displayed, a frame-breaking special effect of the interactive biological object may also be displayed. In some embodiments, in response to the interactive operation on the first social content 211, the frame-breaking special effect of the interactive biological object is displayed in the display interface 210; and display of the frame-breaking special effect is canceled, and the multimedia frame-breaking element 01 is displayed in the display interface 210.

The frame-breaking special effect is configured to indicate a dynamic display process that the interactive biological object moves from the display region of the first social content 211 to another display region in the display interface 210 other than the display region of the first social content 211. Referring to FIG. 2, the user clicks/taps a biological object in the picture sent by the recommender, and then a frame-breaking special effect that the biological object tears a screen and appears is displayed in the display interface 210.

For example, a triggering position of the interactive operation on the first social content 211 may be set according to an actual requirement. For example, the triggering position of the interactive operation is the display position of the interactive biological object, or a position in a region determined according to default settings.

In some embodiments, in response to the interactive operation on a triggering hot spot of the first social content 211, the multimedia frame-breaking element 01 is displayed in the display interface 210. The triggering hot spot is a display region of the interactive biological object, or the triggering hot spot is a region determined based on a display position of the interactive biological object.

The first social content 211 may include a plurality of triggering hot spots, and any two or more of the triggering hot spots may correspond to the same biological object; or the triggering hot spots correspond to different biological objects. For example, the first social content 211 includes a triggering hot spot 1, a triggering hot spot 2, and a triggering hot spot 3. The triggering hot spot 1 corresponds to a first biological object, and the triggering hot spot 2 and the triggering hot spot 3 correspond to a second biological object.

Referring to FIG. 2, an example in which the interactive biological object is a biological object located at a central position in the picture sent by the recommender is used. The triggering hot spot may be a display position of the biological object located at the central position; or the triggering hot spot may be a region including the display position of the biological object located at the central position, and a display position of a periphery of the biological object and/or a blank region.

The multimedia frame-breaking element 01 may be presented in a plurality of forms. For example, the multimedia frame-breaking element 01 is presented in a form of an individual photo of the interactive biological object; or the multimedia frame-breaking element 01 is presented in a form of a group photo including the interactive biological object, a video, or an animation.

In some embodiments, in response to the interactive operation on the triggering hot spot of the first social content 211, an individual multimedia frame-breaking element of the interactive biological object is displayed in the display interface 210, or a combined multimedia frame-breaking element of the interactive biological object is displayed. The individual multimedia frame-breaking element is configured to present an individual visual image of the interactive biological object, and the combined multimedia frame-breaking element is configured to present a combined visual image of the interactive biological object and another biological object other than the interactive biological object.

Referring to FIG. 2, the multimedia frame-breaking element 01 is the individual multimedia frame-breaking element of the interactive biological object. An example in which the interactive biological object is an image of a star is used, the multimedia frame-breaking element 01 is an individual portrait photo of the star, or the multimedia frame-breaking element 01 is a photo of an animated image of the star.

In an implementation, the multimedia frame-breaking element 01 may alternatively be the combined multimedia frame-breaking element of the interactive biological object. In addition to the interactive biological object, the combined multimedia frame-breaking element further includes another biological object other than the interactive biological object. The another biological object may be a biological object displayed in the first social content 211, or may be another biological object not displayed in the first social content 211.

An example in which the first social content 211 includes at least the first triggering hot spot and the second triggering hot spot, the first biological object is displayed in the first triggering hot spot, and the second biological object is displayed in the second triggering hot spot is used. In response to the interactive operation on the first triggering hot spot, the combined multimedia frame-breaking element of the first biological object is displayed in the display interface 210.

In some embodiments, the combined multimedia frame-breaking element of the first biological object includes a first combined multimedia frame-breaking element and a second combined multimedia frame-breaking element. The first combined multimedia frame-breaking element is configured to present a combined visual image of the first biological object and the second biological object, the second combined multimedia frame-breaking element is configured to present a combined visual image of the first biological object and a third biological object, and the third biological object is a biological object not displayed in the first social content 211.

For example, the first biological object is an image of a star, and the second biological object is an image of the spouse of the star. The first combined multimedia frame-breaking element may be a group photo of the star and the spouse thereof, and the second combined multimedia frame-breaking element may be a group photo of the star and a plurality of other stars not displayed in the first social content 211 other than the star.

In an implementation, the interactive biological object may correspond to a plurality of multimedia frame-breaking elements.

In some embodiments, an example in which the interactive biological object corresponds to at least a first multimedia frame-breaking element and a second multimedia frame-breaking element is used, and in response to the interactive operation on the triggering hot spot of the first social content 211, the first multimedia frame-breaking element is displayed in the display interface 210. A display priority of the first multimedia frame-breaking element is higher than a display priority of the second multimedia frame-breaking element.

To improve interaction between the first user account and the recommendation account, the user may also switch the multimedia frame-breaking element. In some embodiments, in response to a switch operation on the first multimedia frame-breaking element, display of the first multimedia frame-breaking element is canceled, and the second multimedia frame-breaking element is displayed.

An example in which the interactive biological object is an image of a star is used, the user continuously presses a pattern of the star, and the first portrait photo of the star is displayed in the display interface 210. Then, the user performs a sliding operation on the portrait photo, display of the portrait photo is canceled, and the second portrait photo is displayed. The second portrait photo is different from the first portrait photo, and a display priority of the second portrait photo is lower than a display priority of the first portrait photo. Alternatively, the user performs a sliding operation on the first portrait photo, display of the first portrait photo is canceled, and a recorded video of the star is displayed. A display priority of the recorded video is lower than the display priority of the first portrait photo.

For example, in response to the triggering operation on the multimedia frame-breaking element 01, an information presenting interface 220 associated with the interactive biological object is displayed.

Referring to FIG. 2, in an implementation, before display of the information presenting interface 220, an interactive special effect 02 corresponding to the interactive biological object may also be displayed, and the information presenting interface 220 is displayed after the interactive special effect 02 is displayed.

The information presenting interface 220 is configured to present related information of a recommended product associated with the interactive biological object. Referring to FIG. 2, content such as product drawings, function displays, and usages of the recommended product is displayed in the information presenting interface 220.

According to different triggering positions of the triggering operation on the multimedia frame-breaking element 01, different interactive special effects 02 are displayed. An example in which the multimedia frame-breaking element 01 is a portrait photo of a star is used. For example, the user clicks/taps a hand of the star, and the interactive special effect 02 is a New Year's greeting animation of the star, referring to FIG. 2; or the user clicks/taps a hair accessory worn on the head of the star, and the displayed interactive special effect 02 is a presenting animation of the star wearing and taking off the hair accessory.

In some embodiments, the triggering position of the triggering operation includes, but is not limited to, at least one of the following positions: an interactive body part of the interactive biological object and an associated object of the interactive biological object. The associated object includes an object on a periphery of the interactive biological object and/or an ornament worn on the interactive biological object.

It is to be understood that different interactive body parts and/or associated objects correspond to different interactive special effects 02. An example in which the triggering position of the triggering operation is the interactive body part of the biological object is used, and in response to a triggering operation on the first body part, a first interactive special effect corresponding to a first body part is displayed; and a first interactive special effect corresponding to a second body part is displayed in response to a triggering operation on the second body part. The first body part and the second body part are different body parts, and the first interactive special effect corresponding to the first body part and the first interactive special effect corresponding to the second body part are different interactive special effects.

Based on the above, according to different triggering positions of the triggering operation, different interactive special effects 02 are displayed. Similarly, after the different interactive special effects 02 are presented, different information presenting interfaces 220 may also be displayed. The displayed information presenting interface 220 may be an interface associated with the interactive body part corresponding to the interactive special effect 02 or the associated object, or may be another interface associated with the interactive biological object, and the another interface and the interface associated with the interactive body part or the associated object are different information presenting interfaces.

An example in which the triggering position of the triggering operation is the associated object of the biological object is used.

A second interactive special effect corresponding to an associated object of the interactive biological object is displayed in response to a triggering operation on the associated object, the associated object including an object on a periphery of the interactive biological object and/or an ornament worn on the interactive biological object; and
display of the second interactive special effect is canceled, and a second information presenting interface corresponding to the associated object is displayed; or the display of the second interactive special effect is canceled, and another information presenting interface corresponding to the interactive biological object other than the second information presenting interface is displayed.

For example, the biological object is an image of a star, and the associated object is a watch worn by the star. The user clicks/taps the watch, the second interactive special effect displayed in the display interface 210 is an animation of the star throwing the watch out of the screen. Then, after the animation is presented, the displayed information presenting interface 220 may be a presenting interface of product information of the watch, or may be a presenting interface of product information of another ornament associated with the star other than the watch.

In an implementation, at least one recommended object may further be displayed in the first social content 211. The recommended object is an inanimate object distinguished from a biological object. For example, recommended objects such as a sofa, a mobile phone, and a game console are displayed in the display region of the first social content 211.

In some embodiments, similar to the interactive operation on the biological object, in response to an interactive operation on the recommended object, a presenting special effect of the recommended object is displayed in the display interface 210; and display of the presenting special effect is canceled, and an information presenting interface corresponding to the recommended object 220 is displayed.

For example, the user continuously presses the game console displayed in the first social content 211, a presenting special effect of product information corresponding to the game console is displayed, and after the presenting special effect is displayed, a presenting interface of the product information of the game console is displayed.

In some embodiments, in some cases, in response to the interactive operation on the first social content 211, the multimedia frame-breaking element 01 may not be displayed. For example, due to poor network speed, the multimedia frame-breaking element 01 cannot be displayed. In this case, the information presenting interface 220 may be directly displayed, to ensure that the interaction between the first user account and the recommendation account can be implemented in an easy form.

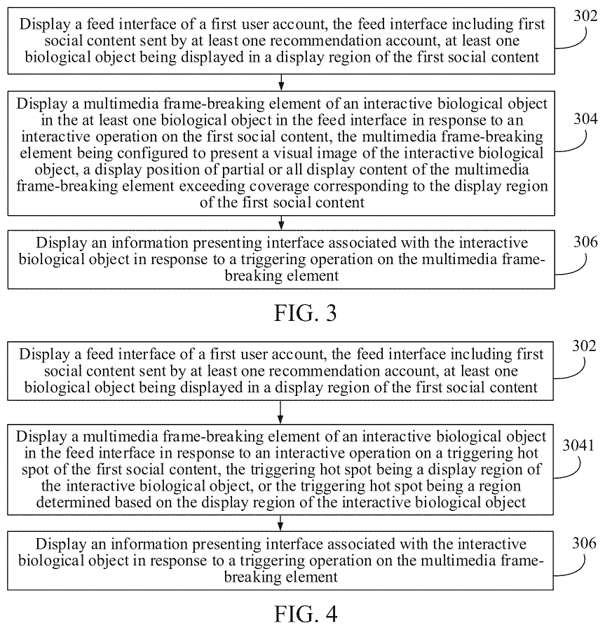

FIG. 3 is a flowchart of an interface display method according to an exemplary embodiment of this application. An example in which the method is applied to the first terminal 120 (or the social interaction platform supporting the feed interface on the first terminal 120) shown in FIG. 1 is used for description in detail, the method including:
Step 302: Display a feed interface of a first user account.

For example, the feed interface includes the first social content sent by at least one recommendation account, and at least one biological object is displayed in a display region of the first social content.

The feed interface is an interface in which social content sent by different content posting accounts are sequentially displayed chronologically, and all the first user account, the recommendation account, and the second user account belong to the content posting accounts.

In some embodiments, the at least one recommendation account is an account that does not have a two-way following relationship with the first user account, or the at least one recommendation account is an account that does not have a two-way following relationship with the first user account.

In some embodiments, social content sent by the first user account may also be displayed in the feed interface.

An interactive operation involved in this application is only associated with the first social content, and does not involve the second social content and the social content sent by the first user account.

For example, a display region of the first social content may be set according to an actual requirement. For example, the display region of the first social content includes a display region of at least one material of copy content, a picture, and a video sent by the recommendation account.

A presenting form of the biological object includes, but is not limited to, one of the following: an image of a recommendation character, an image of a recommendation animal, and an image of an animation character. For example, the biological object is an image of a star; or the biological object is an image of an animated character; or the biological object is an image of a real animal.

Step 304: Display a multimedia frame-breaking element of an interactive biological object in the at least one biological object in the feed interface in response to an interactive operation on the first social content.

For example, the multimedia frame-breaking element is configured to present a visual image of an interactive biological object, and a display position of partial or all display content of the multimedia frame-breaking element exceeds coverage corresponding to the display region of the first social content.

In the feed interface, the display position of the partial or all display content of the multimedia frame-breaking element of the interactive biological object exceeds the coverage corresponding to the display region of the first social content. An example in which the display region of the first social content includes the display region of the copy content and the picture sent by the recommendation account, and the multimedia frame-breaking element is a portrait photo of a star is used. The display region of the multimedia frame-breaking element is a close region with an irregular boundary, and the display position of the multimedia frame-breaking element is a central part of the feed interface. A part of the multimedia frame-breaking element covers the display region of the first social content, and the other part of the multimedia frame-breaking element is located in another region other than the display region of the first social content in the feed interface.

In some embodiments, the multimedia frame-breaking element may also be presented as a floating layer in the feed interface.

The display region of the multimedia frame-breaking element is a floating region located on an upper layer of the feed interface, and a layer level of the floating region is higher than a layer level of the feed interface. In some embodiments, step 304 may be implemented as follows: displaying the multimedia frame-breaking element of the interactive biological object as a floating layer in the feed interface in response to the interactive operation on the first social content.

Referring to FIG. 2, an example in which the multimedia frame-breaking element 01 is a photo of a star, and the display region of the first social content 211 is the display position of the copy content and the picture sent by the recommender is used, and the boundary of the display region of the multimedia frame-breaking element 01 is a body contour line of the star. A part of the body part of the star covers the display region of the first social content 211, and the other part of the body part of the star is located in another region other than the display region of the first social content 211 in the display interface 210.

In the display interface 210, a body part of the star is presented in a form floating above a layer of the social circle displayed in the display interface 210. Other than a part blocked by the body part of the star, other content in the social circle displayed in the display interface 210 can still be seen.

For example, a display effect of the multimedia frame-breaking element 01 is highlight, and a display effect of other content other than the part blocked by the body part of the star in the social circle displayed in the display interface 210 is a light color, for example, gray.

For example, the interactive operation on the first social content may be implemented in a plurality of manners, which may be set according to an actual requirement. The interactive operation on the first social content includes, but is not limited to, at least one of the following operations: a continuous pressing operation, a sliding operation, a single-click/tap operation, a double-click/tap operation, and a touch operation.

In some embodiments, according to different interactive operations, step 304 may be implemented as follows:
displaying the multimedia frame-breaking element in the feed interface in response to the continuous pressing operation on the first social content; or displaying the multimedia frame-breaking element in the feed interface in response to the sliding operation on the first social content; or displaying the multimedia frame-breaking element in the feed interface in response to the single-click/tap operation on the first social content; or displaying the multimedia frame-breaking element in the feed interface in response to the double-click/tap operation on the first social content; or displaying the multimedia frame-breaking element in the feed interface in response to the touch operation on the first social content

For example, the biological object is an image of a star, the user that logs in the first user account continuously presses a pattern of the star displayed in the display interface, the multimedia frame-breaking element corresponding to the star is displayed in the feed interface, and the multimedia frame-breaking element is presented in a form of an artistic photo of the star.

For another example, the biological object is an image of a real animal, the user that logs in the first user account slides on a pattern of the animal, the multimedia frame-breaking element corresponding to the animal is displayed in the feed interface, and the multimedia frame-breaking element is presented in a form of a cute video of the animal.

Step 306: Display an information presenting interface associated with the interactive biological object in response to a triggering operation on the multimedia frame-breaking element.

For example, the information presenting interface is configured to present related information of a recommended product associated with the interactive biological object. The recommended product may be a product endorsed by the interactive biological object. An example in which the interactive biological object is a star is used, the recommended product may be a product endorsed by the star, and the information presenting interface may be a presenting interface of product information of the product.

Similar to the interactive operation, the triggering operation on the multimedia frame-breaking element may also be implemented in a plurality of manners, which may be set according to an actual requirement. In some embodiments, the triggering operation on the multimedia frame-breaking element includes, but is not limited to, at least one of the following operations: a continuous pressing operation, a sliding operation, a single-click/tap operation, a double-click/tap operation, and a touch operation.

An example in which the multimedia frame-breaking element is a portrait photo of a star is used, the user that logs in the first user account single-clicks/taps the portrait photo, and a presenting interface of product information of a product endorsed by the star is displayed.

In conclusion, in the interface display method provided in the embodiments of this application, the multimedia frame-breaking element of the interactive biological object is displayed through the interactive operation on the first social content; and then the information presenting interface associated with the interactive biological object is displayed by triggering the multimedia frame-breaking element. The method enriches manners of interaction between the recommendation account and the first user account, enriches types of man-machine interaction, and further increases frequency of interaction between the recommendation account and the first user account.

According to the above, the triggering position of the interactive operation on the first social content may be set according to an actual requirement. For example, the triggering position of the interactive operation is the display position of the interactive biological object, or a position in a region determined according to default settings. Related descriptions are made below according to limitation to the triggering position of the interactive operation.

Based on FIG. 3, FIG. 4 is a flowchart of an interface display method according to an exemplary embodiment of this application, and step 304 may be implemented as step 3041, which is specifically as follows:
Step 3041: Display the multimedia frame-breaking element of the interactive biological object in the feed interface in response to the interactive operation on a triggering hot spot of the first social content.

The multimedia frame-breaking element is configured to present the visual image of the interactive biological object, and the display position of partial or all display content of the multimedia frame-breaking element exceeds the coverage corresponding to the display region of the first social content.

For example, the related description of the multimedia frame-breaking element may refer to the above, which is not repeated herein again.

In some embodiments, the interactive operation on the triggering hot spot of the first social content includes, but is not limited to, at least one of the following operations: a continuous pressing operation, a sliding operation, a single-click/tap operation, a double-click/tap operation, and a touch operation.

Similar to the above, step 3041 may be implemented as follows:
displaying the multimedia frame-breaking element in the feed interface in response to the continuous pressing operation on the triggering hot spot of the first social content; or displaying the multimedia frame-breaking element in the feed interface in response to the sliding operation on the triggering hot spot of the first social content; or displaying the multimedia frame-breaking element in the feed interface in response to the single-click/tap operation on the triggering hot spot of the first social content; or displaying the multimedia frame-breaking element in the feed interface in response to the double-click/tap operation on the triggering hot spot of the first social content; or displaying the multimedia frame-breaking element in the feed interface in response to the touch operation on the triggering hot spot of the first social content.

For example, the triggering hot spot is a display region of the interactive biological object, or the triggering hot spot is a region determined based on a display position of the interactive biological object.

The first social content may include a plurality of triggering hot spots, and any two or more of the triggering hot spots may correspond to the same biological object; or the triggering hot spots correspond to different biological objects. For example, the first social content includes a triggering hot spot 1, a triggering hot spot 2, and a triggering hot spot 3. The triggering hot spot 1 corresponds to a first biological object, and the triggering hot spot 2 and the triggering hot spot 3 correspond to a second biological object.

An example in which the interactive biological object is a star is used, and the triggering hot spot may be a display region of the star, or may be a region determined according to the display position of the star. For example, the triggering hot spot is a display region enclosed by an irregular boundary of a pattern of the star. For another example, the triggering hot spot is a region determined by the display region enclosed by the irregular boundary of the pattern of the star and a blank region around the irregular boundary.

Referring to FIG. 2, an example in which the interactive biological object is a biological object located at a central position in the picture sent by the recommender is used. The triggering hot spot may be a display position of the biological object located at the central position; or the triggering hot spot may be a region including the display position of the biological object located at the central position, and a display position of a periphery of the biological object and/or a blank region.

In some embodiments, the multimedia frame-breaking element may be classified according to a quantity of objects displayed.

For example, the multimedia frame-breaking element is an individual multimedia frame-breaking element or a combined multimedia frame-breaking element. Only an individual visual image of the interactive biological object is displayed in the individual multimedia frame-breaking element, and the combined multimedia frame-breaking element is configured to present a combined visual image of a biological object and another biological object other than the interactive biological object. For example, the multimedia frame-breaking element is an individual photo of the interactive biological object; or the multimedia frame-breaking element is a group photo including the interactive biological object.

In some embodiments, step 3041 may be implemented as follows:
displaying an individual multimedia frame-breaking element of a biological object in the feed interface in response to the interactive operation on the triggering hot spot, the individual multimedia frame-breaking element being configured to present an individual visual image of the biological object; or
displaying a combined multimedia frame-breaking element of the biological object in the feed interface in response to the interactive operation on the triggering hot spot, the combined multimedia frame-breaking element being configured to present a combined visual image of the biological object and another biological object other than the interactive biological object.

Descriptions are made below in two aspects:

### 1. The Multimedia Frame-Breaking Element is an Individual Multimedia Frame-Breaking Element

The individual multimedia frame-breaking element only includes one biological object with an associated information presenting interface, that is, only including the interactive biological object.

Referring to FIG. 2, the multimedia frame-breaking element 01 is the individual multimedia frame-breaking element of the interactive biological object. An example in which the interactive biological object is an image of a star is used, the multimedia frame-breaking element 01 is an individual portrait photo of the star, or the multimedia frame-breaking element 01 is a photo of an animated image of the star.

### 2. The Multimedia Frame-Breaking Element is a Combined Multimedia Frame-Breaking Element

In an implementation, the multimedia frame-breaking element may alternatively be the combined multimedia frame-breaking element of the interactive biological object. In addition to the interactive biological object, the combined multimedia frame-breaking element further includes at least one biological object with an associated information presenting interface.

In other words, the combined multimedia frame-breaking element includes the interactive biological object and at least one another biological object other than the interactive biological object. The another biological object may be a biological object displayed in the first social content, or may be another biological object not displayed in the first social content.

In an implementation, the first social content includes at least the first triggering hot spot and the second triggering hot spot, the first biological object is displayed in the first triggering hot spot, and the second biological object is displayed in the second triggering hot spot. For example, the first biological object is a star A, the second biological object is a star B, and the first triggering hot spot and the second triggering hot spot are respectively display regions corresponding to the star A and star B.

In some embodiments, the step of displaying a combined multimedia frame-breaking element of the interactive biological object in the feed interface in response to the interactive operation on the triggering hot spot may be implemented as follows:
displaying a first combined multimedia frame-breaking element in the feed interface in response to an interactive operation on the first triggering hot spot or the second triggering hot spot, the first combined multimedia frame-breaking element being configured to present a combined visual image of the first biological object and the second biological object; or
displaying a second combined multimedia frame-breaking element in the feed interface in response to the interactive operation on the first triggering hot spot, the second combined multimedia frame-breaking element being configured to present a combined visual image of the first biological object and a third biological object, the third biological object being a biological object not shown in the first social content.

An example in which the first biological object is the star A, the second biological object is the star B, and the first triggering hot spot and the second triggering hot spot are respectively the display regions corresponding to the star A and star B is still used. The user that logs in the first user account continuously presses the display region of the star A, and a combined multimedia frame-breaking element of the star A is displayed in the feed interface.

For example, the combined multimedia frame-breaking element displayed in the feed interface is a first combined multimedia frame-breaking element, and the first combined multimedia frame-breaking element is a group photo of the star A and the star B.

For another example, the combined multimedia frame-breaking element displayed in the feed interface is a second combined multimedia frame-breaking element, the second combined multimedia frame-breaking element is a group photo of the star A and a star C, and the star C is a biological object not displayed in the first social content.

In some embodiments, in addition to being classified according to the quantity of objects displayed, the multimedia frame-breaking element may also be classified according to a quantity of multimedia frame-breaking elements corresponding to the interactive biological object.

In an implementation, the interactive biological object includes a plurality of multimedia frame-breaking elements.

In some embodiments, the interactive biological object corresponds to at least a first multimedia frame-breaking element and a second multimedia frame-breaking element, and step 304 may alternatively be implemented as follows:
displaying the first multimedia frame-breaking element in the feed interface in response to the interactive operation on the triggering hot spot of the first social content, a display priority of the first multimedia frame-breaking element being higher than a display priority of the second multimedia frame-breaking element,

To improve interaction between the first user account and the recommendation account, the user may also switch the multimedia frame-breaking element. In some embodiments, the interface display method provided in the embodiments of this application further includes:
canceling, in response to a switch operation on the first multimedia frame-breaking element, display of the first multimedia frame-breaking element, and displaying the second multimedia frame-breaking element.

The switch operation on the first multimedia frame-breaking element includes, but is not limited to, at least one of the following operations: a continuous pressing operation, a sliding operation, a single-click/tap operation, a double-click/tap operation, and a touch operation.

An example in which the interactive biological object includes three multimedia frame-breaking elements is used, and the three multimedia frame-breaking elements are respectively a multimedia frame-breaking element 1, a multimedia frame-breaking element 2, and a multimedia frame-breaking element 3. Display priorities of the three multimedia frame-breaking elements decrease in sequence, and the multimedia frame-breaking element 1 has the highest display priority.

The user that logs in the first user account performs the interactive operation on the triggering hot spot of the first social content; then, the multimedia frame-breaking element 1 is displayed in the feed interface; then, the user performs the sliding operation on the multimedia frame-breaking element 1, display of the multimedia frame-breaking element 1 is canceled, and the multimedia frame-breaking element 2 is displayed; and similarly, if the user performs the sliding operation on the multimedia frame-breaking element 2, display of the multimedia frame-breaking element 2 is canceled, and the multimedia frame-breaking element 3 is displayed.

In conclusion, in the interface display method provided in the embodiments of this application, an implementation of the triggering position of the interactive operation of the first social content is provided, and the terminal may trigger display of the multimedia frame-breaking element of the interactive biological object through the interactive operation on the triggering hot spot of the first social content.

In some embodiments, two classification manners of the multimedia frame-breaking element are further provided in the interface display method provided in the embodiments of this application. The multimedia frame-breaking element is classified according to the quantity of the objects displayed in the multimedia frame-breaking element, the multimedia frame-breaking element includes the individual multimedia frame-breaking element and the combined multimedia frame-breaking element. In addition, the multimedia frame-breaking element may also be classified according to the quantity of the multimedia frame-breaking elements corresponding to the interactive biological object, for example, the interactive biological object corresponds to three multimedia frame-breaking elements.

In some embodiments, when the multimedia frame-breaking element includes the combined multimedia frame-breaking element, this application further provides two implementations of the combined multimedia frame-breaking element of the interactive biological object. The first combined multimedia frame-breaking element is configured to present a combined visual image of the interactive biological object and another biological object other than the interactive biological object in the first social content, and the second combined multimedia frame-breaking element is configured to present a combined visual image of the interactive biological object and a third biological object not displayed in the first social content.

According to the plurality of optional solutions above, according to the interactive operation on the triggering hot spot of the first social content, a plurality of implementations of displaying the multimedia frame-breaking element of the interactive biological object are provided, which enriches the manners of interaction between the recommendation account and the first user account, enriches the types of man-machine interaction, and further increases the frequency of interaction between the recommendation account and the first user account.

It is to be understood that the plurality of optional solutions above may be implemented in combination. For example, in response to the interactive operation on the triggering hot spot of the first social content, the individual multimedia frame-breaking element of the interactive biological object is displayed in the feed interface; and in response to the switch operation on the individual multimedia frame-breaking element, display of the individual multimedia frame-breaking element is canceled, and the combined multimedia frame-breaking element of the interactive biological object is displayed.

Other combinations all fall within the protection scope of this application, and are not repeated herein again.

In an implementation, before the multimedia frame-breaking element of the interactive biological object is displayed, a frame-breaking special effect of the interactive biological object may further be displayed, to add interest to the interaction between the first user account and the recommendation account.

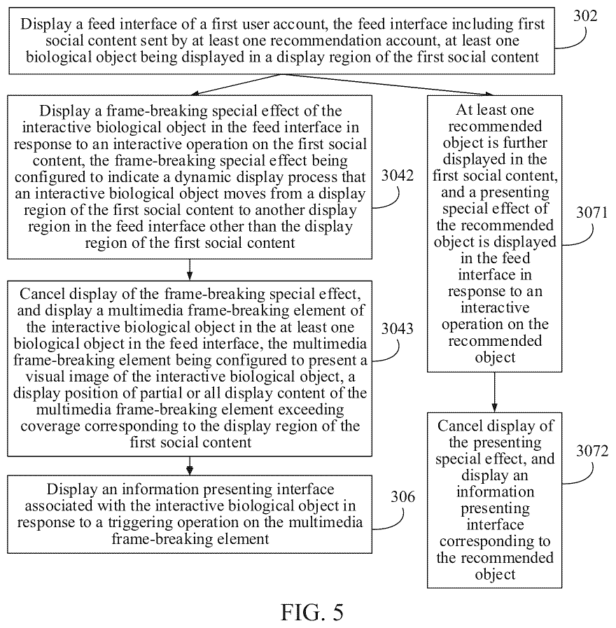

Based on FIG. 3, FIG. 5 is a flowchart of an interface display method according to an exemplary embodiment of this application, and step 304 may be implemented as step 3042 and step 3043, which are specifically as follows:
Step 3042: Display the frame-breaking special effect of the interactive biological object in the feed interface in response to the interactive operation on the first social content.

For example, the frame-breaking special effect is configured to indicate a dynamic display process that the interactive biological object moves from the display region of the first social content to another display region in the feed interface other than the display region of the first social content.

The frame-breaking special effect may be presented in a plurality of forms. For example, the frame-breaking special effect is an animation, a video, or the like. An example in which the interactive biological object is an animation character is used, the user that logs in the first user account continuously presses a pattern of the animation character, and a frame-breaking special effect corresponding to the animation character is displayed in the feed interface. The frame-breaking special effect may be an animation in which the animation character jumps out of the display region of the first social content, and then the animation character is rotated in the feed interface.

Step 3043: Cancel display of the frame-breaking special effect, and display the multimedia frame-breaking element of the interactive biological object in the at least one biological objects in the feed interface.

The multimedia frame-breaking element is configured to present the visual image of the interactive biological object, and the display position of partial or all display content of the multimedia frame-breaking element exceeds the coverage corresponding to the display region of the first social content.

The related description of the multimedia frame-breaking element may refer to the above, which is not repeated herein again.

After the frame-breaking special effect is displayed, the multimedia frame-breaking element of the interactive biological object is displayed in the feed interface. An example in which the interactive biological object is an animation character is still used, the user that logs in the first user account continuously presses the pattern of the animation character, the animation in which the animation character jumps out of the display region of the first social content, and then the animation character is rotated in the feed interface is displayed in the feed interface; and after the animation is played, a picture of the animation character is displayed in the feed interface.

In an implementation, in addition to the biological object, other content may also be displayed in the first social content. For example, a star is displayed in the first social content, and objects such as a sofa, a television, and a lamp are also displayed around the star.

In some embodiments, at least one recommended object is further displayed in the first social content. The interface display method provided in the embodiments of this application further includes step 3071 and step 3072, which are specifically as follows:
Step 3071: Display a presenting special effect of the recommended object in the feed interface in response to an interactive operation on the recommended object.
Step 3072: Cancel display of the presenting special effect, and display an information presenting interface corresponding to the recommended object.

The recommended object is an inanimate object distinguished from a biological object, and the presenting special effect is configured to present related information of the recommended object in the feed interface. For example, recommended objects such as a mobile phone and a game console are displayed in the display region of the first social content.

Similar to the above, an interactive operation on the recommended object includes, but is not limited to, at least one of the following operations: a continuous pressing operation, a sliding operation, a single-click/tap operation, a double-click/tap operation, and a touch operation.

An example in which the recommended object is the sofa, the user that logs in the first user account continuously presses the sofa displayed in the first social content, a presenting special effect of product information corresponding to the sofa is displayed in the feed interface, and after the presenting special effect is displayed, a presenting interface of the product information of the sofa is displayed. The presenting special effect may be an animation of assembly and disassembly of the sofa, to present an overall construction of the sofa.

In an implementation, the multimedia frame-breaking element of the interactive biological object may fail to be displayed. In some embodiments, the interface display method provided in the embodiments of this application further includes:
displaying the information presenting interface when the multimedia frame-breaking element fails to be displayed in response to the interactive operation on the first social content.

In some cases, in response to the interactive operation on the first social content, the multimedia frame-breaking element may not be displayed. For example, due to poor network speed, the multimedia frame-breaking element cannot be displayed. In this case, to present the interaction between the first user account and the recommendation account, the information presenting interface may be directly displayed.

In some embodiments, the interface display method provided in the embodiments of this application further includes:
determining that the multimedia frame-breaking element fails to be displayed when duration after the interactive operation on the first social content exceeds an interactive duration threshold.

The interactive duration threshold may be set according to an actual requirement, for example, the interactive duration threshold is 5 seconds.

An example in which the interactive biological object is a star is used, the user that logs in the first user account continuously presses a pattern of the star. After duration after the continuous pressing operation ends exceeds the interactive duration threshold, a presenting interface of product information of a recommended product associated with the star is directly displayed. For example, the interactive duration threshold is 5 seconds, and an information presenting interface is displayed at the 6^{th} second after the continuous pressing operation ends.

In conclusion, in the interface display method provided in the embodiments of this application, before the multimedia frame-breaking element of the interactive biological object is displayed, the frame-breaking special effect of the interactive biological object may also be displayed, to improve the frequency of the interaction between the first user account and the recommendation account.

In some embodiments, in the interface display method provided in the embodiments of this application, when the multimedia frame-breaking element fails to be displayed, the information presenting interface is directly displayed, avoiding a possibility of failure of the interaction between the first user account and the recommendation account.

In some embodiments, in the interface display method provided in the embodiments of this application, the interactive operation on the recommended object in the first social content is further provided, to display the presenting special effect of the recommended object and the corresponding information presenting interface, which further increases an amount of information included in the first social content, provides more options for the interaction between the first user account and the recommendation account, and further enriches the manners of the interaction between the first user account and the recommendation account, thereby improving the frequency of the interaction between the recommendation account and the first user account.

In an implementation, before the information presenting interface associated with the interactive biological object is displayed, an interactive special effect corresponding to the interactive biological object may further be displayed, to add interest to the interaction between the first user account and the recommendation account.

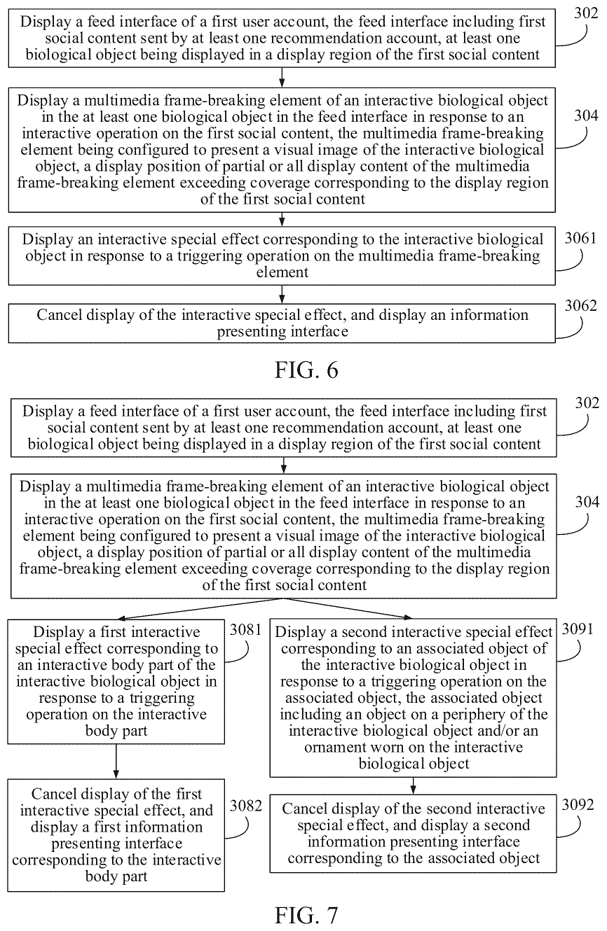

Based on FIG. 3, FIG. 6 is a flowchart of an interface display method according to an exemplary embodiment of this application, and step 306 may be implemented as step 3061 and step 3062, which are specifically as follows:
Step 3061: Display an interactive special effect corresponding to the interactive biological object in response to the triggering operation on the multimedia frame-breaking element.
Step 3062: Cancel display of the interactive special effect, and display the information presenting interface.

For example, the information presenting interface is configured to present related information of a recommended product associated with the interactive biological object. The recommended product may be a product endorsed by the interactive biological object. An example in which the interactive biological object is a star is used, the recommended product may be a product endorsed by the star, and the information presenting interface may be a presenting interface of product information of the product.

In some embodiments, the triggering operation on the multimedia frame-breaking element includes, but is not limited to, at least one of the following operations: a continuous pressing operation, a sliding operation, a single-click/tap operation, a double-click/tap operation, and a touch operation.

The same triggering operation may correspond to a plurality of interactive special effects. For example, the same triggering operation corresponds to three interactive special effects, and one of the interactive special effects may be randomly displayed in response to the triggering operation. Alternatively, in response to the triggering operation, an interactive special effect with the highest display priority is displayed; and in response to a switch operation on the interactive special effect, an interactive special effect with the second highest display priority is displayed.

According to different triggering positions of the triggering operation on the multimedia frame-breaking element, different interactive special effects may also be displayed. An example in which the multimedia frame-breaking element is a portrait photo of a star is used. For example, the user that logs in the first user account clicks/taps a hand of the star, the interactive special effect displayed is an animation of New Year's greeting of the star; or the user clicks/taps a hair accessory worn on the head of the star, and the displayed interactive special effect is a presenting animation of the star wearing and taking off the hair accessory.

In some embodiments, the triggering position of the triggering operation includes, but is not limited to, at least one of the following positions: an interactive body part of the interactive biological object and an associated object of the interactive biological object. The associated object includes an object on a periphery of the interactive biological object and/or an ornament worn on the interactive biological object.

It is to be understood that different interactive body parts and/or associated objects correspond to different interactive special effects. An example in which the triggering position of the triggering operation is the interactive body part of the biological object is used, and in response to a triggering operation on the first body part, a first interactive special effect corresponding to a first body part is displayed; and a first interactive special effect corresponding to a second body part is displayed in response to a triggering operation on the second body part. The first body part and the second body part are different body parts, and the first interactive special effect corresponding to the first body part and the first interactive special effect corresponding to the second body part are different interactive special effects.

An example in which the multimedia frame-breaking element is a portrait photo of a star is used. The user that logs in the first user account may perform a triggering operation on different body parts of the star. For example, the user clicks/taps a hand of the star, the interactive special effect displayed is a New Year's greeting animation of the star; or the user clicks/taps the head of the star, the interactive special effect displayed is an animation of the star touching his or her hair.

Based on the above, according to different triggering positions of the triggering operation, different interactive special effects are displayed. Similarly, after the different interactive special effects are presented, different information presenting interface may also be displayed.

An example in which the multimedia frame-breaking element is a portrait photo of a star is still used. The user that logs in the first user account may perform a triggering operation on different body parts of the star. For example, the user clicks/taps a hand of the star, the interactive special effect displayed is a New Year's greeting animation of the star; and after the animation of the New Year's greeting ends, the feed interface jumps to a presenting interface of product information of a hand cream endorsed by the star. For another example, the user clicks/taps the head of the star, the interactive special effect displayed is the animation of the star touching his or her hair; and after the animation of touching hair ends, the feed interface jumps to a presenting interface of product information of a shampoo endorsed by the star.

In conclusion, in the interface display method provided in the embodiments of this application, before the information presenting interface associated with the interactive biological object is displayed, the interactive special effect corresponding to the interactive biological object may further be displayed, to add interest to the interaction between the first user account and the recommendation account, thereby indirectly improving the frequency of the interaction between the first user account and the recommendation account.

Based on FIG. 6, FIG. 7 is a flowchart of an interface display method according to an exemplary embodiment of this application. Step 3061 may be implemented as step 3081, and step 3062 may be implemented as step 3082; or step 3061 may be implemented as step 3091, and step 3062 may be implemented as step 3092. It is to be understood that step 3081 and step 3091 are alternatively performed, and cannot be both performed.

Based on the above, according to different positions corresponding to the triggering operation, the different interactive special effects are displayed, and descriptions are made below from two aspects:

### 1. The Position Corresponding to the Triggering Operation is an Interactive Body Part of the Interactive Biological Object

In some embodiments, step 3061 may be implemented as step 3081, and step 3062 may be implemented as step 3082, which are specifically as follows:
Step 3081: Display a first interactive special effect corresponding to an interactive body part of the interactive biological object in response to a triggering operation on the interactive body part.
Step 3082: Cancel display of the first interactive special effect, and display a first information presenting interface corresponding to the interactive body part.

Based on the above, the triggering operation is performed on different body parts, and the different first interactive special effects are displayed. In some embodiments, step 3081 may be implemented as follows:
displaying a first interactive special effect corresponding to a first body part in response to a triggering operation on the first body part; and
displaying a first interactive special effect corresponding to a second body part in response to a triggering operation on the second body part.

The first body part and the second body part are different body parts, and the first interactive special effect corresponding to the first body part and the first interactive special effect corresponding to the second body part are different interactive special effects.

An example in which the multimedia frame-breaking element is a portrait photo of a star is used. The user that logs in the first user account may perform a triggering operation on different body parts of the star. For example, the user clicks/taps a hand of the star, the first interactive special effect displayed is a New Year's greeting animation of the star; or the user clicks/taps the head of the star, the first interactive special effect displayed is the animation of the star touching his or her hair.

Based on the above, according to different triggering positions of the triggering operation, different interactive special effects are displayed. Similarly, after the different interactive special effects are presented, different information presenting interface may also be displayed.

After display of the first interactive special effect is canceled, a first information presenting interface corresponding to the interactive body part may be displayed. In some embodiments, the interface display method provided in the embodiments of this application further includes:
canceling the display of the first interactive special effect, and displaying another information presenting interface corresponding to the interactive biological object other than the first information presenting interface.

An example in which the multimedia frame-breaking element is a portrait photo of a star is still used. The user that logs in the first user account clicks/taps the hand of the star, the first interactive special effect displayed is the New Year's greeting animation of the star. Then, after the New Year's greeting animation ends, the feed interface may jump to the information presenting interface of the product information of the hand cream endorsed by the star; or the feed interface jumps to a presenting interface of product information of other skin care products endorsed by the star other than the hand cream.

### 2. The Position Corresponding to the Triggering Operation is the Associated Object of the Interactive Biological Object

In some embodiments, step 3061 may be implemented as step 3091, and step 3062 may be implemented as step 3092, which are specifically as follows:
Step 3091: Display a second interactive special effect corresponding to an associated object of the interactive biological object in response to a triggering operation on the associated object.
Step 3092: Cancel display of the second interactive special effect, and display a second information presenting interface corresponding to the associated object.

For example, the associated object includes an object on the periphery of the interactive biological object and/or an ornament worn on the interactive biological object.

Similar to the above, the triggering operation is performed on different associated objects, and the different first interactive special effects are displayed. In some embodiments, step 3091 may be implemented as follows:
displaying a second interactive special effect corresponding to a first associated object in response to a triggering operation on the first associated object; and
displaying a second interactive special effect corresponding to a second associated object in response to a triggering operation on the second associated object.

The first associated object and the second associated object are different associated objects of the interactive biological object, and the second interactive special effect corresponding to the first associated object and the second interactive special effect corresponding to the second associated object are different interactive special effects.

An example in which the multimedia frame-breaking element is a portrait photo of a star is used. The user that logs in the first user account may perform a triggering operation on different associated objects of the star. For example, the user clicks/taps the clothes of the star, the second interactive special effect displayed is a presenting animation of the clothes; or the user clicks/taps a hair accessory of the star, the second interactive special effect displayed is a presenting animation of the hair accessory.

Based on the above, according to different triggering positions of the triggering operation, different interactive special effects are displayed. Similarly, after the different interactive special effects are presented, different information presenting interface may also be displayed.

After display of the second interactive special effect is canceled, a second information presenting interface corresponding to the associated object may be displayed. In some embodiments, the interface display method provided in the embodiments of this application further includes:
canceling the display of the second interactive special effect, and displaying another information presenting interface corresponding to the interactive biological object other than the second information presenting interface.

An example in which the multimedia frame-breaking element is a portrait photo of a star is still used. The user that logs in the first user account clicks/taps the clothes of the star, and the second interactive special effect displayed is a presenting animation of the clothes. Then, after the presenting animation ends, the feed interface may jump to a presenting interface of product information of the clothes; or the feed interface jumps to a presenting interface of product information of other clothes endorsed by the star other than the clothes.

Based on the above, the associated object includes the object on the periphery of the interactive biological object and/or the ornament worn on the interactive biological object. According to different associated objects, the interactive special effect displayed are different, and descriptions are made in detail below:

### (1) The Associated Object Includes the Object on the Periphery of the Interactive Biological Object.

In some embodiments, step 3091 may be implemented as follows:
displaying a second interactive special effect corresponding to a first object in response to a triggering operation on the first object; and
displaying a second interactive special effect corresponding to a second object in response to a triggering operation on the second object,
the first object and the second object being different objects of the interactive biological object, and the second interactive special effect corresponding to the first object and the second interactive special effect corresponding to the second object being different interactive special effects.

An example in which the multimedia frame-breaking element is a portrait photo of a star is still used.

For example, the first object is a sofa on the periphery of the star, and the second object is a television on the periphery of the star. When the user that logs in the first user account clicks/taps the sofa and the television, the second interactive special effects displayed are different. For example, the second interactive special effect corresponding to the sofa is an animation of the star trying out the sofa, and the second interactive special effect corresponding to the television is an animation of disassembly of the television.

In some embodiments, after the second interactive special effect corresponding to the first object or the second object ends, a first information presenting interface corresponding to the first object or the second object may be displayed, and another information presenting interface associated with the interactive biological object other than the first information presenting interface may also be presented.

For example, after the animation corresponding to the sofa ends, a presenting interface of product information corresponding to the sofa is displayed; or a presenting interface of product information of other household products endorsed by the star other than the sofa is displayed, for example, a presenting interface of product information of a dinner table.

### (2) The Associated Object Includes the Ornament Worn by the Interactive Biological Object.

In some embodiments, step 3091 may be implemented as follows:
displaying a second interactive special effect corresponding to a first ornament in response to a triggering operation on the first ornament; and
displaying a second interactive special effect corresponding to a second ornament in response to a triggering operation on the second ornament,
the first ornament and the second ornament being different objects of the interactive biological object, and the second interactive special effect corresponding to the first ornament and the second interactive special effect corresponding to the second ornament being different interactive special effects.

An example in which the multimedia frame-breaking element is a portrait photo of a star is still used.

For example, the first ornament is a hair accessory worn by the star, and the second ornament is a ring worn by the star. When the user that logs in the first user account clicks/taps the hair accessory and the ring, the second interactive special effects displayed are different. For example, the second interactive special effect corresponding to the hair accessory is an animation of the star wearing and taking off the hair accessory, and the second interactive special effect corresponding to the ring is an animation of the star throwing the ring.

In some embodiments, similar to the object on the periphery of the interactive biological object, after the second interactive special effect corresponding to the first ornament or the second ornament ends, a first information presenting interface corresponding to the first ornament or the second ornament may be displayed, and another information presenting interface associated with the interactive biological object other than the first information presenting interface may also be presented.

For example, after the animation corresponding to the hair accessory ends, a presenting interface of product information corresponding to the hair accessory is displayed; or a presenting interface of product information of other ornaments endorsed by the star other than the hair accessory, for example, a presenting interface of product information of a necklace.

In conclusion, in the interface display method provided in the embodiments of this application, the positions corresponding to the triggering operation are different, and the interactive special effects displayed are different. The position corresponding to the triggering operation may include an interactive body part and an associated object of the interactive biological object. According to different triggering positions, the interactive special effect and the information presenting interface may further be refined, increasing information carried in the multimedia frame-breaking element.

In some embodiments, when the position corresponding to the triggering operation includes the associated object of the interactive biological object, information presenting interfaces of different associated objects associated with the interactive biological object can be presented in a same multimedia frame-breaking element, thereby implementing joint promotion between the different associated objects.

It is to be understood that all the optional solutions provided in the plurality of embodiments above may be implemented in combination.

For example, in response to the continuous pressing operation on the triggering hot spot of the first social content, the frame-breaking special effect of the interactive biological object is displayed in the feed interface; the display of the frame-breaking special effect is canceled, and the individual multimedia frame-breaking element of the interactive biological object is displayed in the feed interface; in response to the single-click/tap operation on the interactive body part of the interactive biological object, the first interactive special effect corresponding to the interactive body part is displayed; and the display of the first interactive special effect is canceled, and the first information presenting interface is displayed.

For another example, in response to the sliding operation on the triggering hot spot of the first social content, the combined multimedia frame-breaking element of the interactive biological object is displayed in the feed interface, and the combined multimedia frame-breaking element is configured to indicate the combined visual image of the interactive biological object and the third biological object not displayed in the first social content; in response to the triggering operation on the object on the periphery of the interactive biological object, the second interactive special effect corresponding to the object is displayed; and the display of the second interactive special effect is canceled, and another information presenting interface associated with the interactive biological object other than the second information presenting interface is displayed.

Other combinations all fall within the protection scope of this application, and are not repeated herein again.

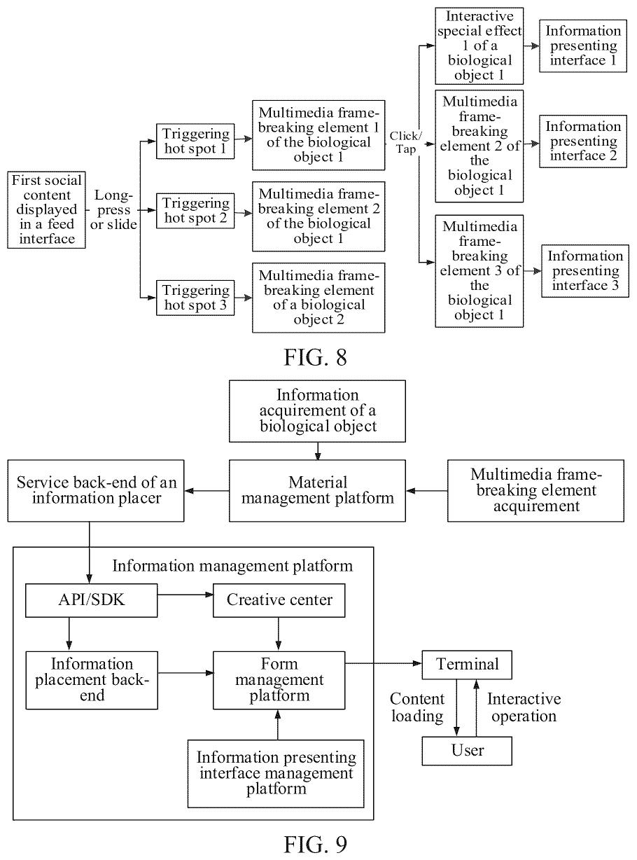

According to the optional solutions provided in the plurality of embodiments above, an example in which the interactive operation on the first social content is a long-press (continuous press) operation or a sliding operation, and the triggering operation on the multimedia frame-breaking element is a click/tap operation is used. FIG. 8 is a flowchart of an interface display method according to an exemplary embodiment of this application.

The first social content displayed in the feed interface includes three triggering hot spots, which are respectively a triggering hot spot 1, a triggering hot spot 2, and a triggering hot spot 3. The triggering hot spot 1 and the triggering hot spot 2 correspond to a biological object 1, and the triggering hot spot 3 corresponds to a biological object 2. The biological object 1 and the biological object 2 are displayed in the first social content, and the biological object 1 corresponds to a multimedia frame-breaking element 1 and a multimedia frame-breaking element 2.

In response to a long-press or a sliding operation on the triggering hot spot 1, the multimedia frame-breaking element 1 of the biological object 1 is displayed. Similarly, in response to a long-press or a sliding operation on the triggering hot spot 2, the multimedia frame-breaking element 2 of the biological object 1 is displayed; and in response to a long-press or a sliding operation on the triggering hot spot 3, a multimedia frame-breaking element of the biological object 2 is displayed.

An example in which the multimedia frame-breaking element 1 of the biological object 1 is displayed is used. The multimedia frame-breaking element 1 corresponds to an interactive special effect 1, an interactive special effect 2, and an interactive special effect 3. In response to a click/tap operation on the multimedia frame-breaking element 1, any of the three interactive special effects may be randomly displayed. Alternatively, in response to the click/tap operation on the multimedia frame-breaking element 1, an interactive special effect with the highest display priority is displayed; and then, in response to a switch operation on the interactive special effect, an interactive special effect with the second highest display priority is switched for display.

For example, different interactive special effects correspond to different information presenting interfaces. The interactive special effect 1 of the biological object 1 is used as an example. In response to the click/tap operation on the multimedia frame-breaking element 1, the interactive special effect 1 of the biological object 1 is displayed, and after the interactive special effect 1 ends, an information presenting interface 1 is displayed.

To implement the interface display method provided in the plurality of embodiments above, the biological object and the multimedia frame-breaking element need to be acquired in advance, and different interactive operations and triggering operations need to be set in advance.

FIG. 9 is a flowchart of an interface display method according to an exemplary embodiment of this application.

First, information acquirement of the biological object and acquirement of the multimedia frame-breaking element needs to be implemented, and acquired information is uploaded to a material management platform.

A service back-end of an information placer is operated by the information placer. When the information placer needs to create a link between the biological object and the information presenting interface, a request may be sent to the material management platform through the service back-end of the information placer, and the material management platform sends the information to the service back-end of the information placer.

Subsequently, the service back-end of the information placer forwards the information to an information management platform, and the information placer continues to perform a creation operation at the information management platform.

For example, the information management platform receives a creation request and relevant parameters of the service back-end of the information placer through an application programming interface (API) or a software development kit (SDK). The relevant parameters include, but are not limited to, at least one of the following parameters: targeting information of recommended product placement crowd, a placement time of the link between the biological object and the information presenting interface, a price of the link, and the like.

Subsequently, the information and the multimedia frame-breaking element of the biological object are sent to a creative center through the API/SDK, and unified management of the material is completed in the creative center. The information placer needs to create a plurality of information presenting interfaces in an information presenting interface management platform; the information placer combines each information presenting interface with information and multimedia frame-breaking elements of different biological objects in a form management platform; and the information placer sets the placement time of the link between the biological object and the information presenting interface at an information placement back-end. For example, a hand hot spot in a multimedia frame-breaking element 1 of a star is combined with an information presenting interface A, and a head hot spot of a multimedia frame-breaking element 1 of a star is combined with an information presenting interface B. Then the material, the information presenting interface, and other information of the recommended product are combined, forming a complete link between the biological object and the information presenting interface for invoking.

Subsequently, in a terminal, if the complete link between the biological object and the information presenting interface needs to be placed in the feed interface of the first user account, the terminal sends a request to the information management platform, and the information management platform sends the complete link between the biological object and the information presenting interface to the terminal in a form of the first social content sent by the recommendation account.

In this case, in the feed interface of the first user account, the first social content sent by the recommendation account is displayed, the user that logs in the first user account may interact with the recommendation account through an interactive operation with the terminal, and the terminal loads content according to the interactive operation of the user.

In conclusion, this embodiment of this application provides an optional implementation of the interface display method, through different matches of a plurality of triggering hot spots, a plurality of biological objects, a plurality of multimedia frame-breaking elements, a plurality of interactive special effects, and a plurality of information presenting interfaces, the interaction between the first user account and the recommendation account is further enriched, so that the frequency of the interaction between the first user account and the recommendation account can be effectively increased.

In some embodiments, according to this embodiment of this application, the link between the biological object and the information presenting interface is further set according to the acquirement of the information and the multimedia frame-breaking element of the biological object. The information placer may randomly set the biological object and the information presenting interface according to an actual requirement, to meet requirements of the information placer.

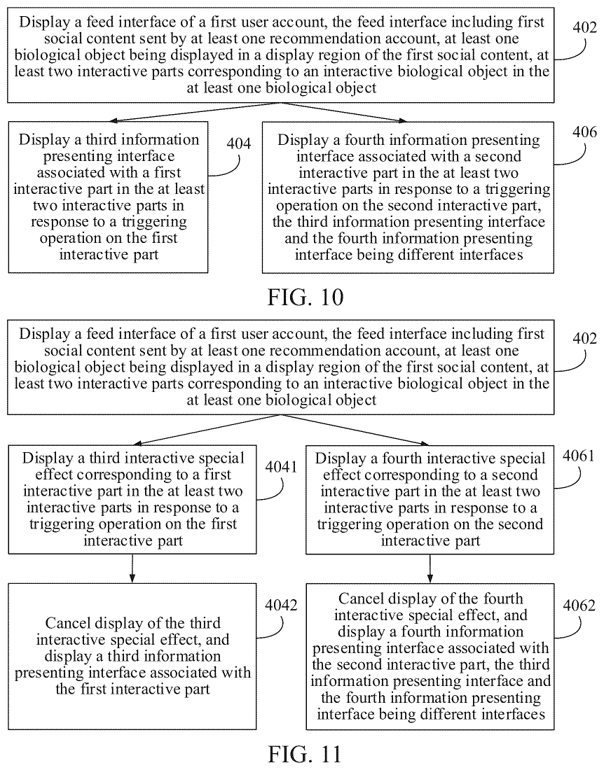

FIG. 10 is a flowchart of an interface display method according to an exemplary embodiment of this application. An example in which the method is applied to the first terminal 120 (or the social interaction platform supporting the feed interface on the first terminal 120) shown in FIG. 1 is used for description in detail, the method including:
Step 402: Display a feed interface of a first user account.

For example, the feed interface includes first social content sent by at least one recommendation account, at least one biological object is displayed in a display region of the first social content, and an interactive biological object in the at least one biological object corresponds to at least two interactive parts.

Descriptions of the feed interface, the recommendation account, and the first social content may refer to the above, and are not repeated herein again.

The interactive biological object is one of the at least one biological object. Based on the above, a presenting form of the biological object includes, but is not limited to, one of the following: an image of a recommendation character, an image of a recommendation animal, and an image of an animation character. An example in which the biological object is an image of a star is used, and the interactive biological object may be one of a plurality of stars displayed in the first social content.

For example, the interactive biological object corresponds to at least two interactive parts. The interactive part may be a body part of the interactive biological object, or may be an ornament worn by the interactive biological object, or may be an object on a periphery of the interactive biological object.

An example in which the interactive biological object is a star is used, the interactive part is at least two of a plurality of body parts of the star, different ornaments worn by the star, and a plurality of objects on a periphery of the star. For example, the interactive part includes the star's head, hands, the upper torso, a hair accessory, a watch, a sofa on which the star leans, and the like.

In some embodiments, second social content sent by at least one second user account is further displayed in the display interface. The at least one second user account is an account that has a two-way following relationship with the first user account. For example, the second user account is a friend account of the first user account. Referring to FIG. 2, the second user account is an “Account A”.

In some embodiments, social content sent by the first user account may also be displayed in the feed interface.

An interactive operation involved in this application is only associated with the first social content, and does not involve the second social content and the social content sent by the first user account.

Step 404: Display a third information presenting interface associated with a first interactive part in the at least two interactive parts in response to a triggering operation on the first interactive part.

Step 406: Display a fourth information presenting interface associated with a second interactive part in the at least two interactive parts in response to a triggering operation on the second interactive part.

It is to be understood that step 404 and step 406 are alternatively performed, and cannot be both performed.

For example, the third information presenting interface is configured to present relevant information of a recommended product associated with the first interactive part, the fourth information presenting interface is configured to present relevant information of a recommended product associated with the second interactive part, and the third information presenting interface and the fourth information presenting interface are different interfaces.

The recommended product may be a product endorsed by the interactive biological object. An example in which the interactive biological object is a star is used, the recommended product may be a product endorsed by the star, and the third information presenting interface or the fourth information presenting interface may be a presenting interface of product information of the product.

Similar to the interactive operation, the triggering operation on the first interactive part or the second interactive part may also be implemented in a plurality of manners, which may be set according to an actual requirement. In some embodiments, the triggering operation on the first interactive part or the second interactive part includes, but is not limited to, at least one of the following operations: a continuous pressing operation, a sliding operation, a single-click/tap operation, a double-click/tap operation, and a touch operation.

Similar to the above, positions corresponding to the triggering operation are different, and the information presenting interfaces displayed are also different. According to relevant descriptions of the first information presenting interface and the second information presenting interface, the triggering operation on the first interactive part or the second interactive part may be the body part of the interactive biological object, or the associated object of the interactive biological object.

In some embodiments, the at least two interactive parts include at least one of the following parts:
the body part of the interactive biological object;
a position of the object on the periphery of the interactive biological object; and
a position of the ornament worn by the interactive biological object.

The object on the periphery of the interactive biological object and the ornament worn by the interactive biological object may be regarded as associated objects of the interactive biological object.

An example in which the at least two interactive parts include the body part of the interactive biological object is used, and step 404 may be implemented as follows: displaying a third information presenting interface associated with a first body part in the at least two interactive parts in response to a triggering operation on the first body part; and step 406 may be implemented as follows: displaying a fourth information presenting interface associated with a second body part in the at least two interactive parts in response to a triggering operation on the second body part.

An example in which the at least two interactive parts include the object on the periphery of the interactive biological object and/or the ornament worn by the interactive biological object is used, and step 404 may be implemented as follows: displaying a third information presenting interface associated with a first associated object in the at least two interactive parts in response to a triggering operation on the first associated object; and step 406 may be implemented as follows: displaying a fourth information presenting interface associated with a second associated object in the at least two interactive parts in response to a triggering operation on the second associated object.

In conclusion, in the interface display method provided in the embodiments of this application, different information presenting interfaces associated with different interactive parts can be triggered through the triggering operation on the corresponding at least two interactive parts performed by a target organism. The method enriches manners of interaction between the recommendation account and the first user account, enriches types of man-machine interaction, and further increases frequency of interaction between the recommendation account and the first user account.

Based on FIG. 10, FIG. 11 is a flowchart of an interface display method according to an exemplary embodiment of this application. Step 404 may be implemented as step 4041 and step 4042, and step 406 may be implemented as step 4061 and step 4062, which are specifically as follows:
Step 4041: Display a third interactive special effect corresponding to the first interactive part in the at least two interactive parts in response to the triggering operation on the first interactive part.
Step 4042: Cancel display of the third interactive special effect, and display the third information presenting interface associated with the first interactive part.
Step 4061: Display a fourth interactive special effect corresponding to the second interactive part in the at least two interactive parts in response to the triggering operation on the second interactive part.
Step 4062: Cancel display of the fourth interactive special effect, and display the fourth information presenting interface associated with the second interactive part.

Based on the above, the at least two interactive parts include at least one of the following parts: the body part of the interactive biological object; a position of the object on the periphery of the interactive biological object; and a position of the ornament worn by the interactive biological object. The object on the periphery of the interactive biological object and the ornament worn by the interactive biological object may be regarded as associated objects of the interactive biological object.

Similar to the above, positions corresponding to the triggering operation are different, and the interactive special effects and the information presenting interfaces displayed are also different. Descriptions are made below according to different parts included in the interactive parts:

### 1. The at Least Two Interactive Parts Include the Body Part of the Interactive Biological Object

In some embodiments, step 4041 and step 4042 may be implemented as follows:
displaying a third interactive special effect corresponding to the first body part of the interactive biological object in response to the triggering operation on the first body part; and canceling display of the third interactive special effect, and display the third information presenting interface associated with the first body part.

In some embodiments, step 4061 and step 4062 may be implemented as follows:
displaying a fourth interactive special effect corresponding to the second body part of the interactive biological object in response to the triggering operation on the second body part; and canceling display of the fourth interactive special effect, and display the fourth information presenting interface associated with the second body part.

The first body part and the second body part are different body parts, and an interactive special effect corresponding to the first body part and an interactive special effect corresponding to the second body part are different interactive special effects.

An example in which the interactive biological object is a star is used. The user that logs in the first user account may perform a triggering operation on different body parts of the star. For example, the user clicks/taps a hand of the star, and the third interactive special effect displayed is a New Year's greeting animation of the star; and the user clicks/taps the head of the star, and the fourth interactive special effect displayed is an animation of the star touching his or her hair.

Based on the above, according to different triggering positions of the triggering operation, different interactive special effects are displayed. Similarly, after the different interactive special effects are presented, different information presenting interface may also be displayed.

Similar to the above, after the display of the third interactive special effect or the fourth interactive special effect is canceled, a corresponding information presenting interface or another display interface may be displayed. In some embodiments, the interface display method provided in the embodiments of this application further includes:
canceling the display of the third interactive special effect, and displaying another information presenting interface corresponding to the interactive biological object other than the third information presenting interface;
and/or canceling the display of the fourth interactive special effect, and displaying another information presenting interface corresponding to the interactive biological object other than the fourth information presenting interface.

An example in which the interactive biological object is a star is still used. The user that logs in the first user account clicks/taps the hand of the star, the third interactive special effect displayed is a New Year's greeting animation of the star. Then, after the New Year's greeting animation ends, the feed interface may jump to the information presenting interface of the product information of the hand cream endorsed by the star; or the feed interface jumps to a presenting interface of product information of other skin care products endorsed by the star other than the hand cream.

### 2. The at Least Two Interactive Parts Include the Position of the Associated Object of the Interactive Biological Object

In some embodiments, step 4041 and step 4042 may be implemented as follows:
displaying the third interactive special effect corresponding to the first associated object of the interactive biological object in response to the triggering operation on the first associated object; and canceling display of the third interactive special effect, and display the third information presenting interface associated with the first associated object.

In some embodiments, step 4061 and step 4062 may be implemented as follows:
displaying the fourth interactive special effect corresponding to the second associated object of the interactive biological object in response to the triggering operation on the second associated object; and canceling display of the fourth interactive special effect, and display the fourth information presenting interface associated with the second associated object.

The first associated object and the second associated object are different associated objects of the interactive biological object, and an interactive special effect corresponding to the first associated object and an interactive special effect corresponding to the second associated object are different interactive special effects.

An example in which the interactive biological object is a star is used. The user that logs in the first user account may perform a triggering operation on different associated objects of the star. For example, the user clicks/taps the clothes of the star, the third interactive special effect displayed is a presenting animation of the clothes; and the user clicks/taps a hair accessory of the star, the fourth interactive special effect displayed is a presenting animation of the hair accessory.

Similar to the above, after the display of the third interactive special effect or the fourth interactive special effect is canceled, a corresponding information presenting interface or another information presenting interface may be displayed. In some embodiments, the interface display method provided in the embodiments of this application further includes:
canceling the display of the third interactive special effect, and displaying another information presenting interface corresponding to the interactive biological object other than the third information presenting interface;
and/or canceling the display of the fourth interactive special effect, and displaying another information presenting interface corresponding to the interactive biological object other than the fourth information presenting interface.

An example in which the interactive biological object is a star is still used. The user that logs in the first user account clicks/taps the clothes of the star, and the third interactive special effect displayed is the presenting animation of the clothes. Then, after the presenting animation ends, the feed interface may jump to a presenting interface of product information of the clothes; or the feed interface jumps to a presenting interface of product information of other clothes endorsed by the star other than the clothes.

In some embodiments, referring to the above, when the at least two interactive parts are the position of the object on the periphery of the interactive biological object and/or the position of the ornament worn by the interactive biological object, step 4041 and step 4042, and step 4061 and step 4062 may also be implemented in other forms, and specific implementations may refer to the related descriptions in step 3091 and step 3092, which are not repeated herein again.

In conclusion, in the interface display method provided in the embodiments of this application, before the information presenting interfaces associated with the different interactive parts are displayed, an implementation of displaying a corresponding interactive special effect is further provided, enriching the manners of the interaction between the recommendation account and the first user account.

It is to be understood that the implementation in this embodiment of this application is similar to the embodiments provided above, which may be referred to and is not repeated herein again.

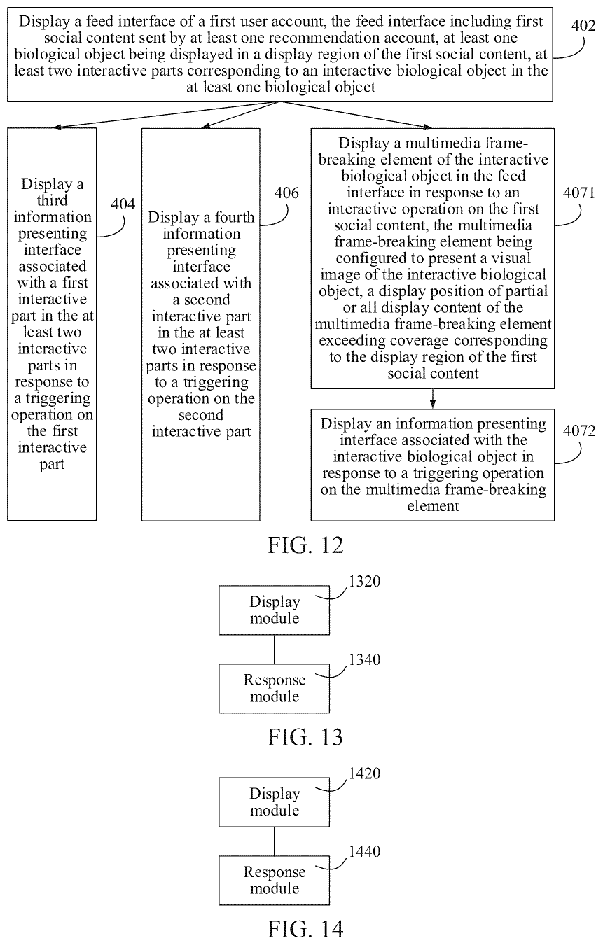

Based on FIG. 10, FIG. 12 is a flowchart of an interface display method according to an exemplary embodiment of this application, and the method further includes step 4071 and step 4072, which are specifically as follows:
Step 4071: Display the multimedia frame-breaking element of the interactive biological object in the feed interface in response to the interactive operation on the first social content.
Step 4072: Display an information presenting interface associated with the interactive biological object in response to a triggering operation on the multimedia frame-breaking element.

For example, the multimedia frame-breaking element is configured to present a visual image of an interactive biological object, and a display position of partial or all display content of the multimedia frame-breaking element exceeds coverage corresponding to the display region of the first social content.

The related description of the multimedia frame-breaking element may refer to the above, which is not repeated herein again.

In some embodiments, the multimedia frame-breaking element may also be presented as a floating layer in the feed interface.

The display region of the multimedia frame-breaking element is a floating region located on an upper layer of the feed interface, and a layer level of the floating region is higher than a layer level of the feed interface. In some embodiments, step 4071 may be implemented as follows: displaying the multimedia frame-breaking element of the interactive biological object as a floating layer in the feed interface in response to the interactive operation on the first social content.

In some embodiments, the interactive operation on the first social content includes, but is not limited to, at least one of the following operations: a continuous pressing operation, a sliding operation, a single-click/tap operation, a double-click/tap operation, and a touch operation.

For example, the biological object is a star, the user that logs in the first user account continuously presses a pattern of the star displayed in the display interface, the multimedia frame-breaking element corresponding to the star is displayed in the feed interface, and the multimedia frame-breaking element is presented in a form of an artistic photo of the star; and then the user single-clicks/taps the artistic photo, and a presenting interface of product information of a product endorsed by the star is displayed.

Based on the above, the triggering operation on the first social content may be for different triggering hot spots.

In some embodiments, step 4071 may be implemented as follows:
displaying the multimedia frame-breaking element of the interactive biological object in the feed interface in response to the interactive operation on a triggering hot spot of the first social content.

For example, the triggering hot spot is a display region of the interactive biological object, or the triggering hot spot is a region determined based on a display position of the interactive biological object.

The first social content may include a plurality of triggering hot spots, and any two or more of the triggering hot spots may correspond to the same biological object; or the triggering hot spots correspond to different biological objects. For example, the first social content includes a triggering hot spot 1, a triggering hot spot 2, and a triggering hot spot 3. The triggering hot spot 1 corresponds to a first biological object, and the triggering hot spot 2 and the triggering hot spot 3 correspond to a second biological object.

An example in which the interactive biological object is a star is used, and the triggering hot spot may be a display region of the star, or may be a region determined according to the display position of the star. For example, the triggering hot spot is a display region enclosed by an irregular boundary of a pattern of the star. For another example, the triggering hot spot is a region determined by the display region enclosed by the irregular boundary of the pattern of the star and a blank region around the irregular boundary.

In some embodiments, the multimedia frame-breaking element may be classified according to a quantity of objects displayed.

For example, the multimedia frame-breaking element is an individual multimedia frame-breaking element or a combined multimedia frame-breaking element. Only an individual visual image of the interactive biological object is displayed in the individual multimedia frame-breaking element, and the combined multimedia frame-breaking element is configured to present a combined visual image of a biological object and another biological object other than the interactive biological object. For example, the multimedia frame-breaking element is an individual photo of the interactive biological object; or the multimedia frame-breaking element is a group photo including the interactive biological object.

In some embodiments, step 4071 may be implemented as follows:
displaying an individual multimedia frame-breaking element of a biological object in the feed interface in response to the interactive operation on the triggering hot spot, the individual multimedia frame-breaking element being configured to present an individual visual image of the biological object; or
displaying a combined multimedia frame-breaking element of the biological object in the feed interface in response to the interactive operation on the triggering hot spot, the combined multimedia frame-breaking element being configured to present a combined visual image of the biological object and another biological object other than the interactive biological object.

In an implementation, the first social content includes at least the first triggering hot spot and the second triggering hot spot, the first biological object is displayed in the first triggering hot spot, and the second biological object is displayed in the second triggering hot spot. For example, the first biological object is a star A, the second biological object is a star B, and the first triggering hot spot and the second triggering hot spot are respectively display regions corresponding to the star A and star B.

In some embodiments, the step of displaying a combined multimedia frame-breaking element of the interactive biological object in the feed interface in response to the interactive operation on the triggering hot spot may be implemented as follows:
displaying a first combined multimedia frame-breaking element in the feed interface in response to an interactive operation on the first triggering hot spot or the second triggering hot spot, the first combined multimedia frame-breaking element being configured to present a combined visual image of the first biological object and the second biological object; or
displaying a second combined multimedia frame-breaking element in the feed interface in response to the interactive operation on the first triggering hot spot, the second combined multimedia frame-breaking element being configured to present a combined visual image of the first biological object and a third biological object, the third biological object being a biological object not shown in the first social content.

In an implementation, the interactive biological object includes a plurality of multimedia frame-breaking elements.

In some embodiments, the interactive biological object corresponds to at least a first multimedia frame-breaking element and a second multimedia frame-breaking element, and step 4071 may alternatively be implemented as follows:
displaying the first multimedia frame-breaking element in the feed interface in response to the interactive operation on the triggering hot spot of the first social content, a display priority of the first multimedia frame-breaking element being higher than a display priority of the second multimedia frame-breaking element.

To improve interaction between the first user account and the recommendation account, the user may also switch the multimedia frame-breaking element. In some embodiments, the interface display method provided in the embodiments of this application further includes:
canceling, in response to a switch operation on the first multimedia frame-breaking element, display of the first multimedia frame-breaking element, and displaying the second multimedia frame-breaking element.

The switch operation on the first multimedia frame-breaking element includes, but is not limited to, at least one of the following operations: a continuous pressing operation, a sliding operation, a single-click/tap operation, a double-click/tap operation, and a touch operation.

Specific implementation of the plurality of optional solutions above may refer to related descriptions in step 3041, which is not repeated herein again.

Based on the above, before the multimedia frame-breaking element is displayed, a frame-breaking special effect may also be displayed.

In some embodiments, step 4071 may be implemented as follows:
displaying the frame-breaking special effect of the interactive biological object in the feed interface in response to the interactive operation on the first social content; and
canceling display of the frame-breaking special effect, and displaying the multimedia frame-breaking element of the interactive biological object in the at least one biological objects in the feed interface.

For example, the frame-breaking special effect is configured to indicate a dynamic display process that the interactive biological object moves from the display region of the first social content to another display region in the feed interface other than the display region of the first social content.

The frame-breaking special effect may be presented in a plurality of forms.

Specific implementation of the solution above may refer to related descriptions in step 3042 and step 3043, which is not repeated herein again.

In some embodiments, at least one recommended object is further displayed in the first social content. The interface display method provided in the embodiments of this application further includes:
displaying a presenting special effect of the recommended object in the feed interface in response to an interactive operation on the recommended object; and
canceling display of the presenting special effect, and displaying an information presenting interface corresponding to the recommended object.

The recommended object is an inanimate object distinguished from a biological object, and the presenting special effect is configured to present related information of the recommended object in the feed interface. For example, recommended objects such as a mobile phone and a game console are displayed in the display region of the first social content.

In an implementation, the multimedia frame-breaking element of the interactive biological object may fail to be displayed. In some embodiments, the interface display method provided in the embodiments of this application further includes:
displaying the information presenting interface when the multimedia frame-breaking element fails to be displayed in response to the interactive operation on the first social content.

In some cases, in response to the interactive operation on the first social content, the multimedia frame-breaking element may not be displayed. For example, due to poor network speed, the multimedia frame-breaking element cannot be displayed. In this case, to present the interaction between the first user account and the recommendation account, the information presenting interface may be directly displayed.

In some embodiments, the interface display method provided in the embodiments of this application further includes:
determining that the multimedia frame-breaking element fails to be displayed when duration after the interactive operation on the first social content exceeds an interactive duration threshold.

Specific implementation of the plurality of optional solutions above may refer to the descriptions above, which is not repeated herein again.

In conclusion, in the interface display method provided in this embodiment of this application, the manners of the interaction between the recommendation account and the first user account are further enriched through the display and triggering of the multimedia frame-breaking element.

In some embodiments, this embodiment of this application further provides an implementation of the triggering position of the interactive operation of the first social content, and two classification manners of the multimedia frame-breaking elements.

It is to be understood that the plurality of optional solutions above may be implemented in combination. For example, in response to the interactive operation on the triggering hot spot of the first social content, the individual multimedia frame-breaking element of the interactive biological object is displayed in the feed interface; and in response to the switch operation on the individual multimedia frame-breaking element, display of the individual multimedia frame-breaking element is canceled, and the combined multimedia frame-breaking element of the interactive biological object is displayed.

It is to be understood that in the interface display method provided in the plurality of embodiments above, the link between the biological object and the information presenting interface may also be set in a setting manner shown in FIG. 9, to meet the requirements of the information placer.

An apparatus embodiment of this application is described below. For details that are not described in detail in the apparatus embodiment, reference may be made to the corresponding records in the foregoing method embodiments, which are not described herein again.

FIG. 13 is a schematic diagram of an interface display apparatus according to an exemplary embodiment of this application. The apparatus includes:
a display module 1320, configured to perform step 302 in the embodiment of FIG. 3; and
a response module 1340, configured to perform step 304 in the embodiment of FIG. 3.

The response module 1340 is further configured to perform step 306 in the embodiment of FIG. 3.

FIG. 14 is a schematic diagram of an interface display apparatus according to an exemplary embodiment of this application. The apparatus includes:
a display module 1420, configured to perform step 402 in the embodiment of FIG. 4; and
a response module 1440, configured to perform step 404 in the embodiment of FIG. 4.

The response module 1440 is further configured to perform step 406 in the embodiment of FIG. 4.

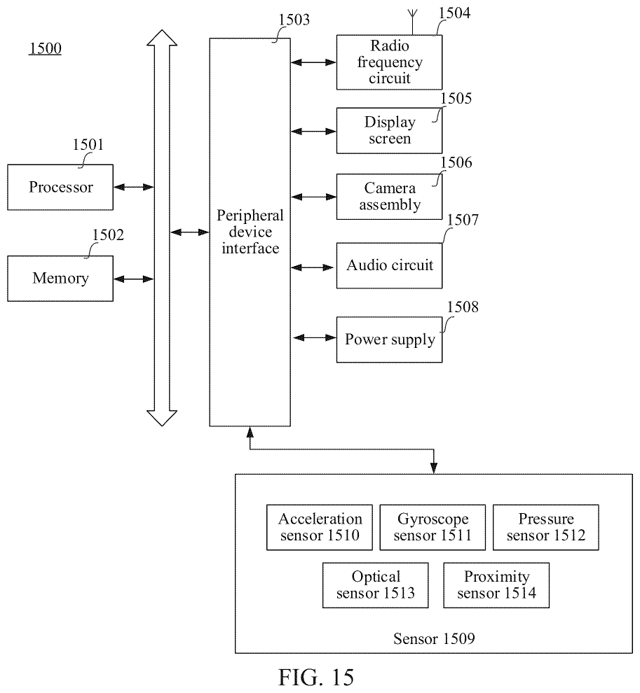

FIG. 15 is a structural block diagram of a computer device 1500 according to an exemplary embodiment of this application. The terminal 1500 may be a portable mobile terminal, such as a smartphone, a tablet computer, a Moving Picture Experts Group Audio Layer III (MP3) player, and a Moving Picture Experts Group Audio Layer IV (MP4) player. The computer device 1500 may also be referred to as another name such as user equipment or a portable terminal.

The computer device 1500 usually includes: a processor 1501 and a memory 1502.

The processor 1501 may include one or more processing cores, for example, a 4-core processor or an 8-core processor. The processor 1501 may be implemented in at least one hardware form of digital signal processor (DSP), a field-programmable gate array (FPGA), and a programmable logic array (PLA). The processor 1501 may also include a main processor and a coprocessor. The main processor is configured to process data in an active state, and is also referred to as a central processing unit (CPU). The coprocessor is a low-power processor configured to process data in a standby state. In some embodiments, the processor 1501 may be integrated with a graphics processing unit (GPU). The GPU is configured to be responsible for rendering and drawing content that a display needs to display. In some embodiments, the processor 1501 may further include an artificial intelligence (AI) processor. The AI processor is configured to process a computing operation related to machine learning.

The memory 1502 may include one or more non-transitory computer-readable storage media. The computer-readable storage medium may be tangible and non-transient. The memory 1502 may further include a high-speed random access memory and a non-volatile memory, for example, one or more disk storage devices or flash storage devices. In some embodiments, the non-transitory computer-readable storage medium in the memory 1502 is configured to store at least one instruction, and the at least one instruction is configured to be executed by the processor 1501 to implement the interface display method provided in the embodiments of this application.

In some embodiments, the computer device 1500 may include: a peripheral device interface 1503 and at least one peripheral device. Specifically, the peripheral device includes: at least one of a radio frequency circuit 1504, a touch display screen 1505, a camera assembly 1506, an audio circuit 1507, and a power supply 1508.

The peripheral device interface 1503 may be configured to connect the at least one peripheral device related to input/output (I/O) to the processor 1501 and the memory 1502. In some embodiments, the processor 1501, the memory 1502, and the peripheral device interface 1503 are integrated on the same chip or the same circuit board. In some other embodiments, any one or two of the processor 1501, the memory 1502, and the peripheral device interface 1503 may be implemented on an independent chip or circuit board. This is not limited in this embodiment.

The radio frequency circuit 1504 is configured to receive and transmit a radio frequency (RF) signal that is also referred to as an electromagnetic signal. The radio frequency circuit 1504 communicates with a communication network and other communication devices through the electromagnetic signal. The radio frequency circuit 1504 converts an electrical signal into an electromagnetic signal for transmission, or converts a received electromagnetic signal into an electrical signal. In some embodiments, the radio frequency circuit 1504 includes: an antenna system, an RF transceiver, one or more amplifiers, a tuner, an oscillator, a digital signal processor, a codec chipset, a user identity module card, and the like. The radio frequency circuit 1504 may communicate with other terminals by using at least one wireless communication protocol. The wireless communication protocol includes, but is not limited to: a world wide web, a metropolitan area network, an intranet, generations of mobile communication networks (2G, 3G, 4G, and 5G), a wireless local area network, and/or a Wi-Fi network. In some embodiments, the radio frequency 1504 may further include a circuit related to Near Field Communication (NFC), which is not limited in this application.

The touch display screen 1505 is configured to display a user interface (UI). The UI may include graphics, text, icons, videos, and any combination thereof. The touch display screen 1505 also has a capability of collecting a touch signal on or above a surface of the touch display screen 1505. The touch signal may be inputted, as a control signal, to the processor 1501 for processing. The touch display screen 1505 is configured to provide a virtual button and/or a comment keyboard, which is also referred to as a soft button and/or a soft keyboard. In some embodiments, there may be one touch display screen 1505, disposed on a front panel of the computer device 1500. In some other embodiments, there may be at least two touch display screens 1505, disposed on different surfaces of the computer device 1500 respectively or in a folded design. In still some other embodiments, the touch display screen 1505 may be a flexible display screen, disposed on a curved surface or a folded surface of the computer device 1500. Even, the touch display screen 1505 may further be set in a non-rectangular irregular pattern, namely, a special-shaped screen. The touch display screen 1505 may be made of a material such as a liquid crystal display (LCD) or an organic light-emitting diode (OLED).

The camera assembly 1506 is configured to collect images or videos. In some embodiments, the camera assembly 1506 includes a front camera and a rear camera. Generally, the front camera is configured to implement a video call or self-portrait. The rear camera is configured to capture a picture or a video. In some embodiments, there are at least two rear cameras, each of which is any one of a main camera, a depth of field camera, and a wide-angle camera, to implement a background blurring function by fusing the main camera and the depth of field camera, and panoramic shooting and VR shooting functions by fusing the main camera and the wide-angle camera. In some embodiments, the camera assembly 1506 may further include a flash. The flash may be a single color temperature flash, or may be a double color temperature flash. The double color temperature flash refers to a combination of a warm flash and a cold flash, and may be used for light compensation at different color temperatures.

The audio circuit 1507 is configured to provide an audio interface between a user and the computer device 1500. The audio circuit 1507 may include a microphone and a speaker. The microphone is configured to collect sound waves of the user and an environment, and convert the sound waves into electrical signals and input the electrical signals to the processor 1501 for processing, or input the electrical signals to the radio frequency circuit 1504 to implement voice communication. For the purpose of stereo sound collection or noise reduction, there may be a plurality of microphones, respectively disposed at different parts of the computer device 1500. The microphone may further be an array microphone or an omnidirectional microphone. The speaker is configured to convert electrical signals from the processor 1501 or the radio frequency circuit 1504 into sound waves. The speaker may be a conventional thin-film speaker or a piezoelectric ceramic speaker. When the speaker is the piezoelectric ceramic speaker, the speaker can not only convert electrical signals into sound waves audible to a human being, but also convert electrical signals into sound waves inaudible to the human being for ranging and other purposes. In some embodiments, the audio circuit 1507 may further include a headphone jack.

The power supply 1508 is configured to supply power to components in the computer device 1500. The power supply 1508 may be an alternating-current power supply, a direct-current power supply, a disposable battery, or a rechargeable battery. When the power supply 1508 includes the rechargeable battery, the rechargeable battery may be a wired charging battery or a wireless charging battery. The wired charging battery is a battery charged through a wired line, and the wireless charging battery is a battery charged through a wireless coil. The rechargeable battery may further be configured to support a quick charge technology.

In some embodiments, the computer device 1500 further includes one or more sensors 1509. The one or more sensors 1509 include, but are not limited to: an acceleration sensor 1510, a gyroscope sensor 1511, a pressure sensor 1512, an optical sensor 1513, and a proximity sensor 1514.

The acceleration sensor 1510 may detect accelerations on three coordinate axes of a coordinate system established by the computer device 1500. For example, the acceleration sensor 1510 may be configured to detect components of gravity acceleration on the three coordinate axes. The processor 1501 may control, according to a gravity acceleration signal collected by the acceleration sensor 1510, the touch display screen 1505 to display the user interface in a transverse view or a longitudinal view. The acceleration sensor 1510 may further be configured to collect data of a game or a user movement.

The gyroscope sensor 1511 may detect a body direction and a rotation angle of the computer device 1500. The gyroscope sensor 1511 may cooperate with the acceleration sensor 1510 to collect a 3D action by the user on the computer device 1500. The processor 1501 may implement the following functions according to the data collected by the gyroscope sensor 1511: motion sensing (for example, change of the UI based on a tilt operation of the user), image stabilization during photographing, game control, and inertial navigation.

The pressure sensor 1512 may be disposed on a side frame of the computer device 1500 and/or a lower layer of the touch display screen 1505. When the pressure sensor 1512 is disposed on the side frame of the computer device 1500, a holding signal of the user on the computer device 1500 may be detected, and left/right hand identification and a quick operation may be performed according to the holding signal. When the pressure sensor 1512 is disposed on the lower layer of the touch display screen 1505, an operable control on the UI may be controlled according to a pressure operation of the user on the touch display screen 1505. The operable control includes at least one of a button control, a scroll-bar control, an icon control, and a menu control.

The optical sensor 1513 is configured to collect ambient light intensity. In an embodiment, the processor 1501 may control the display brightness of the touch display screen 1505 according to the ambient light intensity collected by the optical sensor 1513. Specifically, when the ambient light intensity is relatively high, the display brightness of the touch display screen 1505 is increased, and when the ambient light intensity is relatively low, the display brightness of the touch display screen 1505 is reduced. In another embodiment, the processor 1501 may further dynamically adjust a camera parameter of the camera assembly 1506 according to the ambient light intensity collected by the optical sensor 1513.

The proximity sensor 1514, also referred to as a distance sensor, is usually disposed on a front surface of the computer device 1500. The proximity sensor 1514 is configured to collect a distance between the user and the front surface of the computer device 1500. In an embodiment, when the proximity sensor 1514 detects that the distance between the user and the front surface of the computer device 1500 gradually becomes small, the touch display screen 1505 is controlled by the processor 1501 to switch from a screen-on state to a screen-off state. When the proximity sensor 1514 detects that the distance between the user and the front surface of the computer device 1500 gradually becomes large, the touch display screen 1505 is controlled by the processor 1501 to switch from the screen-off state to the screen-on state.

A person skilled in the art may understand that the structure shown in FIG. 15 does not constitute any limitation on the computer device 1500, and the computer device may include more or fewer components than those shown in the figure, or some components may be combined, or a different component deployment may be used.

This application further provides a non-transitory computer-readable storage medium. The storage medium has a computer program stored therein, and the computer program is configured to be executed by a processor to implement the interface display method described above.

This application further provides a chip. The chip includes a programmable logic circuit and/or program instructions, and is configured to implement the interface display method described above when an electronic device in which the chip is installed runs.

This application further provides a computer program product. The computer program product includes computer instructions, the computer instructions are stored in a computer-readable storage medium, and a processor reads the computer instructions from the computer-readable storage medium and executes the computer instruction to implement the interface display method described above.

In this application, the term “module” refers to a computer program or part of the computer program that has a predefined function and works together with other related parts to achieve a predefined goal and may be all or partially implemented by using software, hardware (e.g., processing circuitry and/or memory configured to perform the predefined functions), or a combination thereof. Each module can be implemented using one or more processors (or processors and memory). Likewise, a processor (or processors and memory) can be used to implement one or more modules. Moreover, each module can be part of an overall module that includes the functionalities of the module.

What is claimed is:

1. An interface display method performed by a computer device, the method comprising:
displaying a feed interface of a first user account of a social networking platform, the feed interface comprising at least one object displayed within a frame of the feed interface;
in response to an interactive operation on the first social content, displaying the at least one object breaking out of the frame and becoming a multimedia frame-breaking element of an interactive object with a body contour of the at least one object remaining within the frame; and
displaying an information presenting interface associated with the interactive object in replacement of the feed interface in response to a triggering operation on the multimedia frame-breaking element.

2. The method according to claim 1, wherein the displaying the at least one object breaking out of the frame and becoming a multimedia frame-breaking element of an interactive object comprises:
displaying the multimedia frame-breaking element in the feed interface in response to an interactive operation on a triggering hot spot of the first social content corresponding to a portion of the interactive object.

3. The method according to claim 2, wherein the displaying the multimedia frame-breaking element in the feed interface in response to an interactive operation on a triggering hot spot of the first social content comprises:
displaying an individual multimedia frame-breaking element of the interactive object in the feed interface in response to the interactive operation on the triggering hot spot, the individual multimedia frame-breaking element being configured to present an individual visual image of the interactive object; or
displaying a combined multimedia frame-breaking element of the interactive object in the feed interface in response to the interactive operation on the triggering hot spot, the combined multimedia frame-breaking element being configured to present a combined visual image of the interactive object and another object other than the interactive object.

4. The method according to claim 1, wherein the displaying the at least one object breaking out of the frame and becoming a multimedia frame-breaking element of an interactive object comprises:
displaying a frame-breaking special effect of the interactive object in the feed interface in response to the interactive operation on the first social content, the frame-breaking special effect being configured to indicate a dynamic display process that the interactive object moves out of the frame of the feed interface.

5. The method according to claim 1, wherein the displaying the at least one object breaking out of the frame and becoming a multimedia frame-breaking element of an interactive object comprises:
displaying the multimedia frame-breaking element in the feed interface in response to one of a continuous pressing operation on the first social content or a sliding operation on the first social content or a single-click/tap operation on the first social content or a double-click/tap operation on the first social content or a touch operation on the first social content.

6. The method according to claim 1, wherein the displaying an information presenting interface associated with the interactive object in replacement of the feed interface in response to a triggering operation on the multimedia frame-breaking element comprises:
displaying an interactive special effect corresponding to the interactive object in response to the triggering operation on the multimedia frame-breaking element; and
canceling display of the interactive special effect, and displaying the information presenting interface.

7. The method according to claim 1, wherein the information presenting interface associated with the interactive object varies based on a location of the triggering operation on the multimedia frame-breaking element.

8. A computer device, comprising a memory and a processor, the processor having at least one piece of program code stored therein, the program code being loaded and executed by the processor and causing the computer device to perform an interface display method including:
displaying a feed interface of a first user account of a social networking platform, the feed interface comprising at least one object displayed within a frame of the feed interface;
in response to an interactive operation on the first social content, displaying the at least one object breaking out of the frame and becoming a multimedia frame-breaking element of an interactive object with a body contour of the at least one object remaining within the frame; and
displaying an information presenting interface associated with the interactive object in replacement of the feed interface in response to a triggering operation on the multimedia frame-breaking element.

9. The computer device according to claim 8, wherein the displaying the at least one object breaking out of the frame and becoming a multimedia frame-breaking element of an interactive object comprises:
displaying the multimedia frame-breaking element in the feed interface in response to an interactive operation on a triggering hot spot of the first social content corresponding to a portion of the interactive object.

10. The computer device according to claim 9, wherein the displaying the multimedia frame-breaking element in the feed interface in response to an interactive operation on a triggering hot spot of the first social content comprises:
displaying an individual multimedia frame-breaking element of the interactive object in the feed interface in response to the interactive operation on the triggering hot spot, the individual multimedia frame-breaking element being configured to present an individual visual image of the interactive object; or
displaying a combined multimedia frame-breaking element of the interactive object in the feed interface in response to the interactive operation on the triggering hot spot, the combined multimedia frame-breaking element being configured to present a combined visual image of the interactive object and another object other than the interactive object.

11. The computer device according to claim 8, wherein the displaying the at least one object breaking out of the frame and becoming a multimedia frame-breaking element of an interactive object comprises:
displaying a frame-breaking special effect of the interactive object in the feed interface in response to the interactive operation on the first social content, the frame-breaking special effect being configured to indicate a dynamic display process that the interactive object moves out of the frame of the feed interface.

12. The computer device according to claim 8, wherein the displaying the at least one object breaking out of the frame and becoming a multimedia frame-breaking element of an interactive object comprises:
displaying the multimedia frame-breaking element in the feed interface in response to one of a continuous pressing operation on the first social content or a sliding operation on the first social content or a single-click/tap operation on the first social content or a double-click/tap operation on the first social content or a touch operation on the first social content.

13. The computer device according to claim 8, wherein the displaying an information presenting interface associated with the interactive object in replacement of the feed interface in response to a triggering operation on the multimedia frame-breaking element comprises:
displaying an interactive special effect corresponding to the interactive object in response to the triggering operation on the multimedia frame-breaking element; and
canceling display of the interactive special effect, and displaying the information presenting interface.

14. The computer device according to claim 8, wherein the information presenting interface associated with the interactive object varies based on a location of the triggering operation on the multimedia frame-breaking element.

15. A non-transitory computer-readable storage medium, having a computer program stored therein, the computer program being configured to be executed by a processor of a computer device and causing to the computer device to perform an interface display method including:
displaying a feed interface of a first user account of a social networking platform, the feed interface comprising at least one object displayed within a frame of the feed interface;
in response to an interactive operation on the first social content, displaying the at least one object breaking out of the frame and becoming a multimedia frame-breaking element of an interactive object with a body contour of the at least one object remaining within the frame; and
displaying an information presenting interface associated with the interactive object in replacement of the feed interface in response to a triggering operation on the multimedia frame-breaking element.

16. The non-transitory computer-readable storage medium according to claim 15, wherein the displaying the at least one object breaking out of the frame and becoming a multimedia frame-breaking element of an interactive object comprises:
displaying the multimedia frame-breaking element in the feed interface in response to an interactive operation on a triggering hot spot of the first social content corresponding to a portion of the interactive object.

17. The non-transitory computer-readable storage medium according to claim 15, wherein the displaying the at least one object breaking out of the frame and becoming a multimedia frame-breaking element of an interactive object comprises:
displaying a frame-breaking special effect of the interactive object in the feed interface in response to the interactive operation on the first social content, the frame-breaking special effect being configured to indicate a dynamic display process that the interactive object moves out of the frame of the feed interface.

18. The non-transitory computer-readable storage medium according to claim 15, wherein the displaying the at least one object breaking out of the frame and becoming a multimedia frame-breaking element of an interactive object comprises:
displaying the multimedia frame-breaking element in the feed interface in response to one of a continuous pressing operation on the first social content or a sliding operation on the first social content or a single-click/tap operation on the first social content or a double-click/tap operation on the first social content or a touch operation on the first social content.

19. The non-transitory computer-readable storage medium according to claim 15, wherein the displaying an information presenting interface associated with the interactive object in replacement of the feed interface in response to a triggering operation on the multimedia frame-breaking element comprises:
displaying an interactive special effect corresponding to the interactive object in response to the triggering operation on the multimedia frame-breaking element; and
canceling display of the interactive special effect, and displaying the information presenting interface.

20. The non-transitory computer-readable storage medium according to claim 15, wherein the information presenting interface associated with the interactive object varies based on a location of the triggering operation on the multimedia frame-breaking element.
